(19) United States
(12) Patent Application Publication
(10) Pub. No.: US 2026/0238342 A1
(43) Pub. Date: Aug. 13, 2026

(54) OPTICAL COMMUNICATION SERVICE

(71) Applicant: AEROCINE VENTURES, INC., Jackson Heights, NY (US)

(72) Inventors: Brian Streem, Jackson Heights, NY (US); Vijaykumar Sureshkumar, Jersey City, NJ (US)

(73) Assignee: AEROCINE VENTURES, INC., Jackson Heights, NY (US)

(21) Appl. No.: 19/411,175

(22) Filed: Dec. 5, 2025

Related U.S. Application Data
(60) Provisional application No. 63/728,283, filed on Dec. 5, 2024.

(51) Int. Cl. H04B 10/112

(52) U.S. Cl. CPC H04B 10/1123; H04B 10/1129

(57) ABSTRACT

Systems, methods, and computer-readable media for optically communicating between vehicles are provided.

### CROSS-REFERENCE TO RELATED APPLICATION(S)

This application claims the benefit of prior filed U.S. Provisional Patent Application No. 63/728,283, filed Dec. 5, 2024, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to an optical communication service, and, more particularly, to systems, methods, and computer-readable media for optically communicating between vehicles.

### BACKGROUND OF THE DISCLOSURE

Autonomous vehicles may often communicate with one another using radio frequency communication. However, this may fail when network communication is restricted or denied.

### SUMMARY OF THE DISCLOSURE

This document describes systems, methods, and computer-readable media for optically communicating between vehicles.

For example, a method of receiving at a first communication subsystem a message from a second communication subsystem may be provided, where there method may include storing, in memory of the first communication subsystem, a look-up table including a plurality of entries, wherein each entry includes a unique message and a unique optical detection, after the storing, detecting, with an optical sensor assembly of the first communication subsystem, optical signals from the second communication subsystem during a state change of the second communication subsystem, generating, with the optical sensor assembly of the first communication subsystem, optical data based on the detected optical signals, identifying, with the optical sensor assembly, a particular entry of the plurality of entries whose unique optical detection matches the generated optical data, and controlling, with the first communication subsystem, a functionality of a managed element of the first communication subsystem based on the unique message of the identified particular entry.

As another example, a method of communicating a message from a first communication subsystem may be provided, where the method may include storing, in memory of the first communication subsystem, a look-up table including a plurality of entries, wherein each entry includes a unique message and a unique optical configuration, after the storing, selecting, with the first communication subsystem, the unique message of a particular entry of the plurality of entries to be identified by another communication subsystem, and, after the selecting, reconfiguring, with the first communication subsystem, an output component of the first communication subsystem based on the unique optical configuration of the particular entry.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for providing an optical communication service of the disclosure, in accordance with one or more implementations;

FIG. 1A is a more detailed schematic view of a subsystem of the system of FIG. 1, in accordance with one or more implementations;

FIG. 1B is a more detailed schematic view of a communication subsystem of the system of FIG. 1, in accordance with one or more implementations;

FIG. 1C is a more detailed schematic view of multiple communication subsystems of the system of FIG. 1, in accordance with one or more implementations;

FIG. 1D is an exemplary data structure that may be used by a communication subsystem of the system of FIG. 1, in accordance with one or more implementations;

FIG. 2 is a detailed schematic view of a portion of a communication subsystem of the system of FIG. 1, in accordance with one or more implementations;

FIG. 3 is a detailed schematic view of a portion of a communication subsystem of the system of FIG. 1, in accordance with one or more implementations;

FIGS. 4 and 5 are exemplary flowcharts of various processes for providing optical communication services of the disclosure, in accordance with one or more implementations; and

FIG. 6 illustrates an example electronic system with which aspects of the subject technology may be implemented, in accordance with one or more implementations.

### DETAILED DESCRIPTION OF THE DISCLOSURE

The present disclosure relates generally to an optical communication service, and, more particularly, to systems, methods, and computer-readable media for optically communicating between vehicles. This disclosure may provide an optical communication service (“OCS”) or OCS platform (“OCSP”), which may be referred to herein as an OCS protocol or OCSP protocol or the like, that can facilitate optical communication between two or more communication subsystems, which may include one or more autonomous vehicles. This may be particularly useful when network communication is restricted or denied and the two communication subsystems may not use radio frequency (“RF”) communication. Such optical communication may be accomplished completely on board the two communicating subsystems, may be totally passive, may be unsusceptible to jamming, and may be not reliant on any network communication (e.g., Wi-Fi, Bluetooth, navigation satellite, etc.). An individual communication subsystem may be a mobile subsystem, such as any suitable vehicle, and may be configured to localize itself (e.g., determine its geolocation (e.g., GPS coordinates) and/or an orientation of one or more of its cameras) without active network communication (e.g., as described by U.S. Pat. No. 12,366,459, which is hereby incorporated by reference herein in its entirety). The OCSP of this disclosure may enable such a vehicle to communicate with another suitable communication subsystem using optical radiation (e.g., detectable vehicle movement, detectable vehicle heat, detectable vehicle component physical reconfiguration, detectable vehicle component color reconfiguration, etc. (e.g., without the use of radio waves)).

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

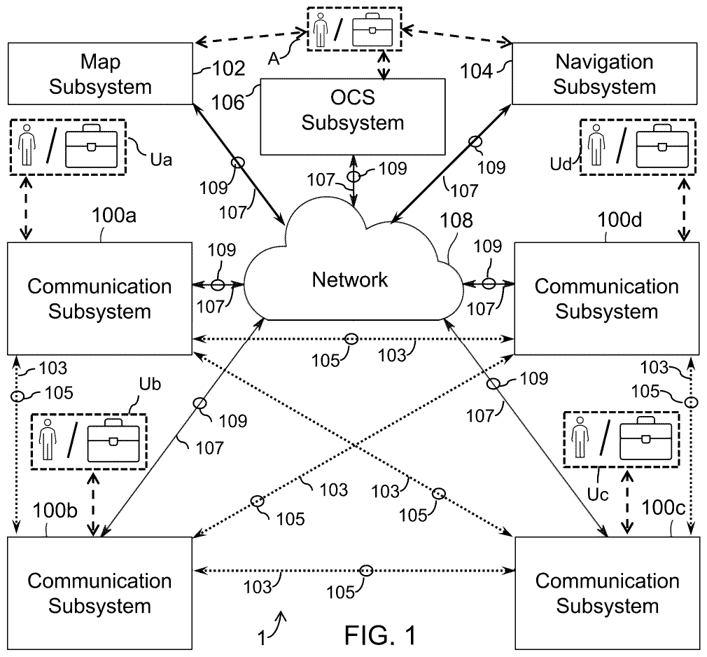

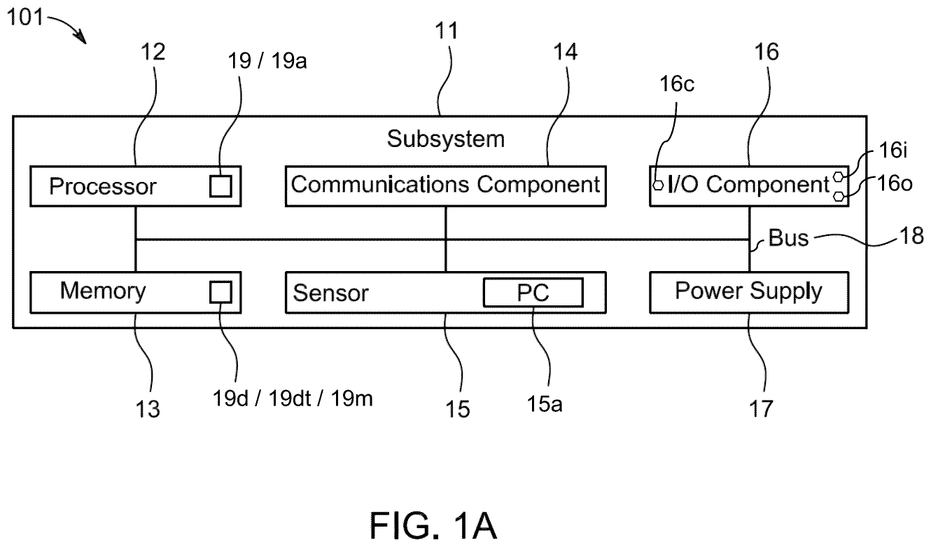

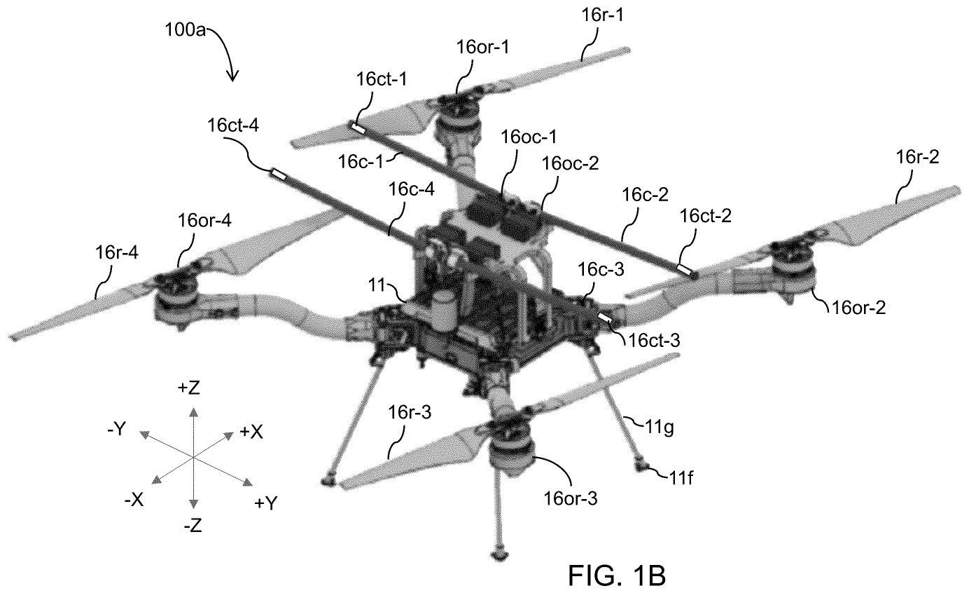

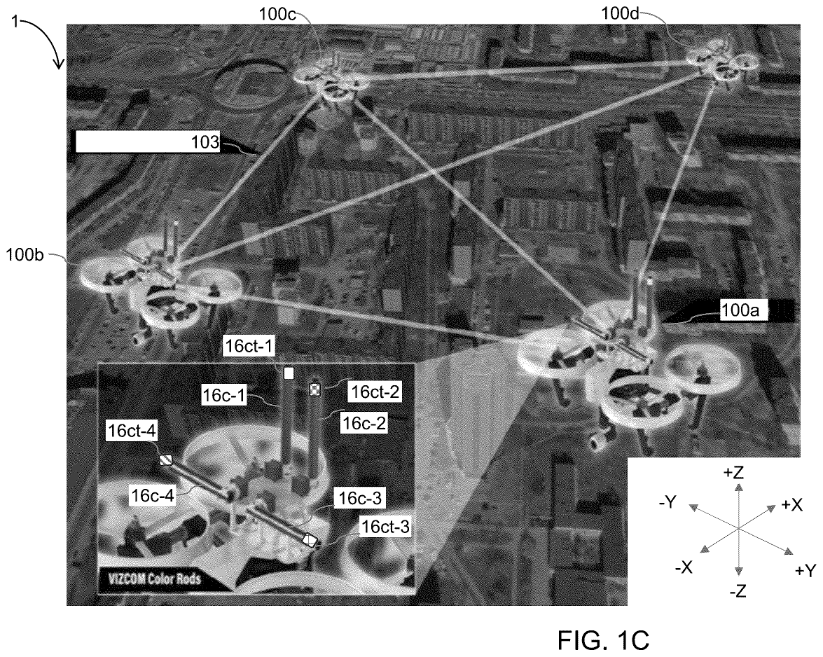

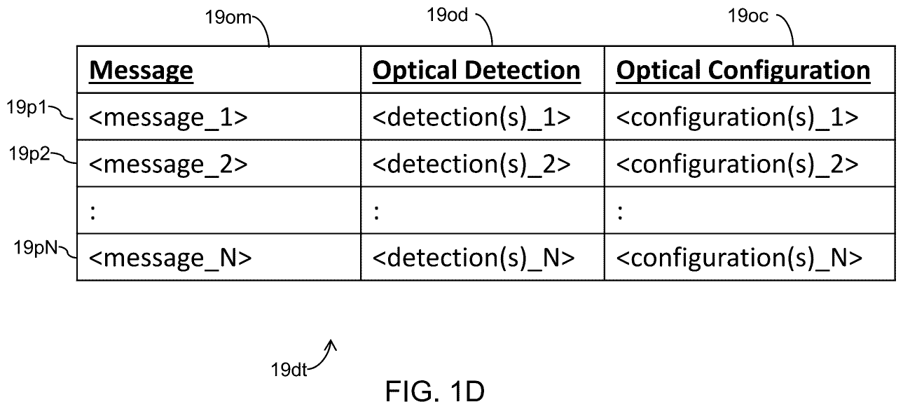

FIG. 1 is a schematic view of an illustrative system 1 in which communication between communication subsystems (e.g., network-restricted communication subsystems) may be facilitated utilizing an optical communication service (“OCS”). For example, as shown in FIG. 1, system 1 may include an OCS subsystem 106, one or more map subsystems 102, one or more navigation subsystems 104, one or more observing or communication subsystems 100 (e.g., communication subsystems 100a-100d), and at least one communications network 108 through which any two or more subsystems of system 1 may communicate using RF communication (e.g., radio wave communication (e.g., Wi-Fi, Bluetooth, cellular, navigation satellite, etc.) using any suitable computer network communication protocol). A map subsystem 102 may be any suitable subsystem that may be configured to collect map data of any suitable environment (e.g., real-world map data) using any suitable techniques with or without the use of any independent navigation subsystem(s) 104. A navigation subsystem 104 may be any suitable subsystem that may be configured to provide any suitable navigation data for any suitable remote subsystem (e.g., a subsystem 102 and/or a subsystem 100) using any suitable techniques (e.g., as a global navigation satellite system (“GNSS”) or any suitable positioning, navigation, and timing (“PNT”) system (e.g., satellite-based PNT system), such as a global positioning system (“GPS”), etc.). An OCS subsystem 106 may be any suitable subsystem that may be configured to collect and process any suitable map data from one or more map subsystems 102 and any suitable navigation data from one or more navigation subsystems 104 (e.g., directly or via a map subsystem) and/or any other suitable data from any other suitable subsystem(s) (e.g., any suitable third party subsystem (not shown)) using any suitable techniques for creating any suitable map database(s) that may be used for providing a localization processing service (“LPS”) to a mobile communication subsystem 100 (e.g., as described by U.S. Pat. No. 12,366,459, which is hereby incorporated by reference herein in its entirety) and/or that may be configured to define and share any suitable OCS protocol with one or more communication subsystems 100. A communication subsystem 100 may be any suitable subsystem that may be configured to communicate with another suitable communication subsystem using any suitable OCS protocol, such as by using any suitable optical radiation (e.g., detectable vehicle movement, detectable vehicle heat, detectable vehicle component physical reconfiguration, detectable vehicle component color reconfiguration, etc. (e.g., without the use of radio waves)). In some embodiments, a communication subsystem 100 may be any suitable roving or mobile communication subsystem 100 that may be configured to collect image data of its surroundings and determine its location and/or orientation using any suitable techniques with or without the active use of any independent map subsystem(s) 102, navigation subsystem(s) 104, and/or OCS subsystem(s) 106 (e.g., as described by U.S. Pat. No. 12,366,459, which is hereby incorporated by reference herein in its entirety). OCS subsystem 106 may be operated, managed, or otherwise at least partially controlled by any suitable entity (e.g., an administrator A) that may be responsible for defining an OCS protocol for use by any suitable communication subsystems 100 and/or for creating any suitable map database(s) that may be used for providing a localization processing service (“LPS”) to a mobile communication subsystem 100. In some embodiments, map subsystem 102 and/or navigation subsystem 104 may be at least partially controlled by administrator A or by any other distinct entity (e.g., a third party entity (e.g., a satellite operator, a mapper, etc.). Each communication subsystem 100 may be operated, managed, or otherwise at least partially controlled by any suitable entity (e.g., a user U (e.g., users Ua, Ub, Uc, and Ud of respective subsystems 100a-100d, which may be the same user U (e.g., a single user responsible for all or at least two or more of the communication subsystems) or distinct users each responsible for a respective communication subsystem or subset of communication subsystems)).

Map subsystem 102 may be any suitable subsystem that may be configured to be utilized to travel within any suitable environment (e.g., a real-world environment or a projected virtual (e.g., three dimensional (“3D”)) environment or the like) for mapping the map subsystem's location and/or orientation within/with respect to the environment. Examples of a physical structure or housing of a map subsystem 102 may include, but are not limited to, any suitable portable, mobile, wearable, implantable, rideable, controllable, or hand-held mobile electronic device (e.g., a portable telephone and/or handheld media player), a headset, a helmet, glasses, a tablet computer, a laptop computer, a spatial tracking system, a controller, a virtual reality (“VR”) and/or augmented reality (“AR”) and/or mixed reality (“MR”) device, a ring, a necklace, an augmented reality device, a mixed reality device, an unmanned or autonomous vehicle (“AV”), an aerial vehicle (e.g., an aerial AV), an airplane, a helicopter, a drone (e.g., a multirotor drone, fixed wing drone, etc.), a terrain vehicle, an aquatic vehicle, a hover vehicle, any combination thereof, and/or any other machine or device or housing or structure that can be utilized to travel within an environment for mapping its location and/or orientation within the environment. Map subsystem 102 may also include any suitable localization system that may be configured to collect any suitable map data that may be used to determine location(s)/orientation(s) of the map subsystem as it travels within an environment to be mapped. For example, map subsystem 102 may include one or more of the following types of localization systems: gyroscope, accelerometer, a camera, a gimbal, a light source, a sensor, motion capture, GPS (e.g., in conjunction with one or more navigation subsystems 104), real time kinematic (“RTK”) GPS, electromagnetic tracking, inertial, ultra-sonic, ultra-wideband locating, visual marker/marker-less tracking, visual odometry, GPS-inertial odometry, visual-inertial odometry (“VIO”), LiDAR (e.g., light detection and ranging; laser imaging, detection, and ranging), sonar (sound navigation and ranging), iBeacon/tag, simultaneous localization and mapping (“SLAM”), structure-from-motion (“SfM”), Wi-Fi localization, and/or the like.

Navigation subsystem 104 may be any suitable subsystem that may be configured to be utilized to communicate with or track a map subsystem 102 to determine any suitable navigation data that may be used to determine the positioning (e.g., location(s)s/orientation(s)) of the map subsystem as it travels within an environment. Navigation subsystem 104 may include one or more satellites, beacons, antennas, and/or the like that may be positioned throughout the world or with respect to a particular environment and that may be configured (e.g., in conjunction with any suitable memory, processor(s), applications, and/or the like) to communicate with or otherwise detect a map subsystem 102 to determine such navigation data associated with the map subsystem's location using any suitable navigation protocols and/or techniques (e.g., GNSS, GPS, etc.).

OCS subsystem 106, which may also be configured as an LPS subsystem, may be any suitable subsystem that may be configured to be utilized to collect and process any suitable map data from one or more map subsystems 102 and any suitable navigation data from one or more navigation subsystems 104 and/or map subsystems 102 and/or any other suitable data from any other suitable subsystem(s) (e.g., any suitable third party subsystem (not shown)) using any suitable techniques for creating any suitable map database(s) (e.g., localized map database(s)) and/or for receiving any suitable map database(s) that may be used for providing a localization processing service to a mobile subsystem 100. Such map database(s) may include, but are not limited to, geo-specific three-dimensional representations of the planet or other physical or projected virtual environment(s) that may include a digital elevation model (“DEM”), digital surface model (“DSM”), and/or digital terrain model (“DTM”) (e.g., Precision3D or Vricon3D database), any suitable artificial intelligence (“AI”)-generated 3D models and previsualization tools (e.g., Vermeer3D database), interactive panoramas of georeferenced images (e.g., of stitched virtual reality (“VR”) photographs) of an environment (e.g., Street View database (e.g., Google Street View) or any georeferenced image(s)), satellite stereoscopic image(s), orthoimage(s), and/or the like. For example, the map can be generated from satellite images (e.g., a Maxar Precision 3D map (e.g., One World Terrain), or Google Earth 3D map), from images (e.g., by the use of photogrammetry techniques and solvers (e.g., colmap, meshroom, and/or the like)), from LiDAR, and/or from any other suitable capture technique that may be able to generate 3D data. Once map database(s) have been generated or otherwise accessed by OCS subsystem 106, such map or LPS databases may be utilized (e.g., by OCS subsystem 106 or otherwise (e.g., with one or more map samplers and/or one or more map feature extractors)) to generate or at least partially define one or more map feature databases with any suitable types of map features that may be extracted from the LPS databases (e.g., along with their 3D or georeferenced coordinates) or map renderings thereof using any suitable techniques. Such map feature databases or portions thereof may then be provided by OCS subsystem 106 to one or more mobile communication subsystems 100. Alternatively, such map feature databases or portions thereof may be generated or at least partially defined by a mobile communication subsystem 100 using any suitable map or LPS databases. OCS subsystem 106 may correspond to any suitable subsystem (e.g., mobile device, tablet computer, laptop computer, server(s), etc.) that may be capable of providing LPS data to a mobile subsystem (e.g., directly or via any suitable communications network). In some embodiments, OCS subsystem 106 and map subsystem 102 may correspond to the same subsystem. Additionally or alternatively, OCS subsystem 106 may be configured to define and share any suitable OCS protocol with one or more communication subsystems 100.

A communication subsystem 100 may be any suitable subsystem that may be configured to communicate with (e.g., detect a communication from or generate a communication for) another communication subsystem 100 of system 1 using any suitable OCS protocol. Additionally, in some embodiments, one or more communication subsystems 100 of system 1 may be any suitable communication subsystem that may be configured to collect images of its surroundings and inertial data (e.g., indicative of its orientation) using any suitable techniques and to process such data in conjunction with any suitable map feature databases to localize the communication subsystem (e.g., with or without the use of any independent navigation subsystem(s) 104). At least one communication subsystem 100 of system 1 may be a mobile communication subsystem 100. Examples of a physical structure or housing of an observing or mobile communication subsystem 100 may include, but are not limited to, any suitable portable, mobile, wearable, implantable, rideable, controllable, or hand-held mobile electronic device (e.g., a portable telephone and/or handheld media player), a headset, a helmet, glasses, goggles, a tablet computer, a laptop computer, a spatial tracking system, a controller, a VR and/or AR and/or MR device, a ring, a necklace, an augmented reality device, a mixed reality device, an unmanned or autonomous vehicle (“AV”), an aerial vehicle (e.g., an aerial AV), an airplane, a helicopter, a drone (e.g., a multirotor drone, a fixed wing drone, etc.), a terrain vehicle, an aquatic vehicle, a hover vehicle, any combination thereof, and/or any other machine or device or housing or structure that can be utilized (e.g., autonomously or by any human controller onboard or otherwise that may be dictating the movement of the structure) to travel within an environment for mapping its location and/or orientation within the environment. In some embodiments, a mobile communication subsystem 100 may include the same localization system or a similar localization system to that of a map subsystem. For example, a mobile communication subsystem 100 may include one or more of the following types of localization systems: gyroscope, accelerometer, a camera, a gimbal, a light source, a sensor, motion capture, GPS (e.g., in conjunction with one or more navigation subsystems 104), real time kinematic (“RTK”) GPS, electromagnetic tracking, inertial, ultra-sonic, ultra-wideband locating, visual marker/marker-less tracking, visual odometry, GPS-inertial odometry, visual-inertial odometry (“VIO”), LIDAR, iBeacon/tag, simultaneous localization and mapping (“SLAM”), structure-from-motion (“SfM”), Wi-Fi localization, and/or the like. However, in some embodiments, a mobile communication subsystem 100 may be navigation-restricted and/or navigation network-restricted, where the mobile communication subsystem may be at least temporarily limited or permanently denied in its ability to communicate with or be detected by a navigation subsystem (e.g., a navigation subsystem 104). For example, a mobile communication subsystem 100 may be at least temporarily GPS-denied or GNSS-denied or GPS-spoofed to disable or make inaccurate the network tracking of the mobile subsystem's location. In some embodiments, a map subsystem may be capable of generating maps while a mobile communication subsystem may be able to perform localization but not generate maps, whereby a mobile communication subsystem may have lighter hardware than a map subsystem. A mobile communication subsystem 100 may be configured to receive any suitable LPS data and/or map features and/or map feature database(s) from an OCS subsystem 106 and/or from a map subsystem 102 (e.g., directly or via any suitable communications network 108 (e.g., wired and/or wirelessly (e.g., via Bluetooth, NFC, Zigbee interface, WLAN, USB, and/or generally any communication interface))) prior to or during the mobile communication subsystem's travel through an environment in order to enable the mobile communication subsystem to determine its location and/or orientation with respect to the environment despite the mobile communication subsystem being navigation network-restricted. In some embodiments, one or more communication subsystems 100 of system 1 may be a non-mobile communication subsystem 100 that may not be mobile but may be temporarily or permanently or substantially permanently fixed at a particular location (e.g., as a base station, etc.). Each communication subsystem 100 of system 1 may be configured to communicate with at least one other communication subsystem 100 of system 1 using any suitable OCS protocol (e.g., without the active use of a communication network 108 or any RF signaling).

One, some, or each subsystem of system 1 may be configured communicate with another one, some, or each subsystem of system 1 via any suitable communications network 108. Network 108 may be the internet or any other network, such that when interconnected, a first subsystem may access information (e.g., map data, navigation data, LPS data, etc.) from a second subsystem as if such information were stored locally at that first subsystem. One, some, or each communications component or communications interface of a first subsystem and/or one, some, or each communications component or communications interface of a second subsystem may be a network interface that may include the mechanical, electrical, and/or signaling circuitry for communicating data over one or more telecommunications links (e.g., data links, physical links, virtual circuits, etc.) or communication signal channels (e.g., transmission line-based telecommunications cable(s) and/or radio/broadcast channel of any suitable network 108. For example, any suitable radio wave signal communication channels 107 may be provided by network 108 for connecting any two of subsystems 100a-100d, 102, 104, and 106 using any suitable computer networking telecommunications protocol(s) of any suitable network type(s) (e.g., Wi-Fi, Bluetooth, NFC, PAN, LAN, WAN, cloud, internet, etc.) for communicating any suitable radio wave signal(s) 109. Additionally, when any two communication subsystems 100 are within a certain distance of one another without any obstruction therebetween, any suitable optical signal communication channel 103 (e.g., a visual communication link) may be realized between the two communication subsystems 100 for connecting the two subsystems 100 using any suitable OCS protocol(s) for communicating any suitable optical signal(s) 105. For example, a channel 103 may be a line of sight between two communication subsystems that may enable the communication of any suitable optical radiation or optical signal(s) 105 (e.g., detectable vehicle movement, detectable vehicle heat, detectable vehicle component physical reconfiguration, detectable vehicle component color reconfiguration, etc.) of one of the communication subsystems to the other communication subsystem of that channel. For example, optical signal(s) 105 may be any suitable electromagnetic radiation greater than 300 MHz (e.g., infrared light, visible light, ultraviolet light), while radio wave signal(s) 109 may be any suitable electromagnetic radiation less than 300 MHz (e.g., radio waves, microwaves, etc.).

Although only a single one of each of subsystems 100a-100d, 102, 104, and 106 are shown in FIG. 1, system 1 may include two or more of one, some, or each of subsystems 100a-100d, 102, 104, and 106, and/or different networks 108 may be provided for enabling communication between different subsystems. Multiple map subsystems may be used to map different portions of an environment. Different navigation subsystems may be used to service different map subsystems or different portions of an environment. Different OCS subsystems may service different mobile subsystems and/or different portions of an environment. Different mobile subsystems may be used in the same or different portions of an environment (e.g., for collaboration). In some embodiments, one or more subsystems of system 1 may be combined or omitted.

As shown in FIG. 1A, a subsystem 101 of system 1 (e.g., one, some, or each of subsystems 100a-100d, 102, 104, and 106 of system 1 of FIG. 1) may include a processor component 12, a memory component 13, a communications component 14, a sensor 15, an input/output (“I/O”) component 16, a power supply component 17, a structure or housing 11, and/or a bus 18 that may provide one or more wired or wireless communication links or paths for transferring data and/or power to, from, or between various other components of subsystem 101. In some embodiments, one or more components of subsystem 101 may be combined or omitted. Moreover, subsystem 101 may include other components not combined or included in FIG. 1A and/or several instances of the components shown in FIG. 1A. For the sake of simplicity, only one of each of the components of subsystem 101 is shown in FIG. 1A.

I/O component 16 may include at least one input component 16i (e.g., a button, mouse, keyboard, etc.) to receive information from a user or other device and/or at least one output component 16o (e.g., an audio speaker, video display, haptic component (e.g., rumbler, vibrator, etc.), olfactory output component, lighting output component(s) and/or movement actuator(s) and/or heat/cooling actuators for providing any suitable optical communication configurations, etc.) to provide information or any other suitable support to a user or other device, such as a touch screen that may receive input information through a user's touch of a display screen and that may also provide visual information to a user via that same display screen, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like. For example, certain output component(s) 16o of subsystem 101 may be configured to enable subsystem 101 to communicate any suitable optical radiation or optical signal(s) 105 (e.g., detectable vehicle movement, detectable vehicle heat, detectable vehicle component physical reconfiguration, detectable vehicle component color reconfiguration, etc.) over a channel 103 to another subsystem 101 in accordance with any suitable OCS protocol. As an example, any suitable output component(s) 16o may be configured to move the whole of subsystem 101 (e.g., housing 11) along and/or about any suitable axis (e.g., to adjust a position and/or orientation of a rigid body with a 6-vector signal (e.g., along any of six degrees of freedom (“6 DOF”)), such as with any suitable motor(s) or rotor(s) or the like) for adjusting an optical signal 105 (e.g., as may be detected by any suitable motion capture sensing technologies of another communication subsystem pursuant to a shared OCS protocol). Additionally or alternatively, any suitable output component(s) 16o may be configured to move any suitable detectable OCS component(s) 16c subsystem 101 (e.g., wings, repositionable rods, and/or the like within or extending from housing 11) independently from any other component(s) of subsystem 101 and/or independently from movement of subsystem 101 as a whole along and/or about any suitable axis (e.g., to adjust a position and/or orientation of a rigid body with a 6-vector signal (e.g., along any of six degrees of freedom (“6 DOF”)), such as with any suitable motor(s) or rotor(s) or the like, such that the subsystem 101 as a whole could be moving along the X-axis while rotating about the Y-axis (e.g., a drone vehicle communication subsystem 100a flying through space), while any suitable adjustable OCS component 16c of that subsystem 101 may be independently moved in relation to another component of that subsystem 101 along the Z-axis (e.g., a first adjustable OCS component 16c of the subsystem (e.g., a repositionable rod) may be adjusted (e.g., moved closer to, moved away from, rotated in any suitable manner, etc. along the Z-axis) in relation to another OCS component 16c of the subsystem (e.g., a foot of the drone (e.g., a foot 11f of a leg 11g of FIG. 1B)) for adjusting an optical signal 105 (e.g., as may be detected by any suitable motion capture sensing technologies of another communication subsystem pursuant to a shared OCS protocol). Additionally or alternatively, any suitable output component(s) 16o may be configured to adjust the shape of any suitable adjustable OCS component 16c of that subsystem 101 (e.g., through inflating or deflating a portion of a rod component, extending a finger from a rod, etc.) for adjusting an optical signal 105 (e.g., as may be detected by any suitable visible image camera of another communication subsystem pursuant to a shared OCS protocol). Additionally or alternatively, any suitable output component(s) 16o may be configured to adjust the color of any suitable adjustable OCS component 16c of that subsystem 101 (e.g., through changing the color of a light being emitted by a light emitter of an OCS component 16c or adjusting which one of a number of different color housing portions are visibly exposed to a channel 103 for adjusting an optical signal 105 (e.g., as may be detected by any suitable visible image camera of another communication subsystem pursuant to a shared OCS protocol)). Additionally or alternatively, any suitable output component(s) 16o may be configured to adjust the temperature of any suitable adjustable OCS component 16c of that subsystem 101 (e.g., through heating or cooling any suitable material of the OCS component) for adjusting an optical signal 105 (e.g., as may be detected by any suitable thermal camera of another communication subsystem pursuant to a shared OCS protocol).

Memory 13 may include one or more storage mediums or media, including for example, a hard-drive, flash memory, magnetic storage, permanent memory such as read-only memory (“ROM”), semi-permanent memory such as random access memory (“RAM”), any other suitable type of storage component, or any combination thereof (e.g., for storing any suitable data (e.g., OCSP data 19d (e.g., unique subsystem identifier information, models, neural networks, algorithms, application data, OCS protocol data, etc.) and/or any suitable service system management model 19m (e.g., that may be used by or as any suitable application 19a))). Memory 13 may include suitable logic, circuitry, and/or code that may enable storage of various types of information, such as received data, generated data, code, and/or configuration information.

Communications component 14 may be provided to allow subsystem 101 to communicate any suitable signals 109 with one or more other subsystems 101 using any suitable communications protocol(s) (e.g., via communications network 108). Communications component 14 can be operative to create or connect to a communications network (e.g., network 108). Communications component 14 can provide wireless communications using any suitable short-range or long-range communications protocol, such as Wi-Fi (e.g., an 802.11 protocol), ZigBee™ (e.g., an 802.15.4 protocol), WiDi™, Ethernet, Bluetooth™, Bluetooth™ Low Energy (“BLE”), ultra-wideband, radio frequency systems (e.g., 1200 MHz, 2.4 GHz, and 5.6 GHz communication systems), high frequency systems (e.g., 900 MHz, 2.4 GHz, and 5.6 GHz communication systems), near field communication (“NFC”), infrared, protocols used by wireless and cellular telephones and personal e-mail devices, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, wireless local area network (“WLAN”), universal serial bus (“USB”), protocols used by wireless and cellular telephones and personal e-mail devices, or any other protocol supporting wireless communications, any other communications protocol, or any combination thereof. Communications component 14 can also be operative to connect to a wired communications network or directly to another data source wirelessly or via one or more wired connections. Communications component 14 may be a network interface that may include the mechanical, electrical, and/or signaling circuitry for communicating data over physical link(s) and/or data link(s) that may be coupled to network 108. Such network interface(s) may be configured to transmit and/or receive any suitable data using a variety of different communication protocols, including, but not limited to, TCP/IP, UDP, ATM, synchronous optical networks (“SONET”), any suitable wireless protocols, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access. Communications component 14 may also include or may be electrically coupled to any suitable transceiver circuitry that can enable subsystem 101 to be communicatively coupled to another subsystem and communicate data with that other subsystem wirelessly or via a wired connection (e.g., using a connector port). Communications component 14 (and/or sensor assembly 15) may be configured to determine a geographical position of subsystem 101 and/or any suitable data that may be associated with that position. For example, communications component 14 may utilize a global positioning system (“GPS”) or a regional or site wide positioning system that may use cell tower positioning technology or Wi-Fi™ technology, or any suitable location based service or real time locating system, which may use a geo-fence for providing any suitable location based data to subsystem 101 (e.g., to determine a current geo location of subsystem 101 and/or any other suitable associated data). Communications component 14 may include or otherwise provide a network interface that may include mechanical, electrical, and/or signaling circuitry for communicating any suitable data over any suitable physical links that may be coupled to network 108.

Sensor 15 may be any suitable sensor that may be configured to sense any suitable data for subsystem 101 (e.g., location-based data via a GPS sensor system, image data, inertia or inertial data, motion data, environmental data, biometric data, etc.). Sensor 15 may be a sensor assembly that may include any suitable sensor or any suitable combination of sensors operative to detect any suitable characteristic(s) of subsystem 101 and/or of a user thereof and/or of its environment/surroundings (e.g., physical activity or other characteristics of a user of subsystem 101, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, image sensor, inertial sensor (e.g., inertial measurement unit (“IMU”)), accelerometer, directional sensor (e.g., compass), gyroscope, motion sensor, pedometer, passive infrared sensor, ultrasonic sensor, microwave sensor, thermal camera (e.g., thermographic camera, thermal imager, infrared camera, etc.), gesture detector, dual-technology motion detectors, motion capture sensing technologies, a tomographic motion detector, image camera, video camera, biometric sensor, light sensor, timer, and/or the like. Sensor 15 may include one or more image sensors for capturing video image data and/or still image data (e.g., sensor 15 may include a rear-facing camera and/or a front-facing camera and/or any other directional camera (e.g., on a gimballed and/or gyrostabilized platform and/or the like) and/or the like). Sensor 15 may include any suitable sensor components or subassemblies for detecting any suitable movement of subsystem 101 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions.

Additionally or alternatively, sensor 15 may include one or more angular rate, inertial, and/or gyro-motion sensors or gyroscopes for detecting rotational movement (e.g., any suitable inertial measurement unit (“IMU”), such as a gyroscope and/or an accelerometer and/or a magnetometer sensor (e.g., a Gauss meter, a magnetic measurement unit (“MMU”), an inertial MMU (“IMMU”), etc.)). For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, attitude sensors (e.g., for roll, pitch, yaw, etc.) and/or the like. Any other suitable sensors may also or alternatively be provided by sensor 15 for detecting motion on subsystem 101, such as any suitable pressure sensors, altimeters, or the like. Using sensor 15, subsystem 101 may be configured to determine a velocity, acceleration, orientation, and/or any other suitable motion attribute of subsystem 101. Sensor 15 may include any suitable sensor components or subassemblies for detecting any suitable biometric data and/or health data and/or sleep data and/or mindfulness data and/or the like of a user of user subsystem 101. For example, sensor 15 may include any suitable biometric sensor that may include, but is not limited to, one or more facial recognition sensors, fingerprint scanners, iris scanners, retinal scanners, voice recognition sensors, gait sensors, hair sensors, hand geometry sensors, signature scanners, keystroke dynamics sensors, vein matching sensors, heart beat sensors, body temperature sensors, odor or scent sensors, behavioral biometric sensors (e.g., user behavioral modeling of movement, orientation, gesture, pausality, etc.), DNA sensors, sensors for any unclonable or extremely difficult to replicate personal function, and/or any other suitable sensors for detecting any suitable metrics related to any suitable characteristics of a user, which may also include health-related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. These sensors can generate data providing health-related information associated with the user. For example, PPG sensors can provide information regarding a user's respiratory rate, blood pressure, and/or oxygen saturation. ECG sensors can provide information regarding a user's heartbeats. GSR sensors can provide information regarding a user's skin moisture, which may be indicative of sweating and can prioritize a thermostat application to determine an entity's temperature. One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 101 for attempting to authenticate a user), line-in connector for data and/or power, and/or combinations thereof. In some examples, each sensor can be a separate device, while, in other examples, any combination of two or more of the sensors can be included within a single device. For example, a gyroscope, accelerometer, photoplethysmogram, galvanic skin response sensor, and temperature sensor can be included within a wearable subsystem 101, such as a smart watch, while a scale, blood pressure cuff, blood glucose monitor, SpO2 sensor, respiration sensor, posture sensor, stress sensor, and asthma inhaler can each be separate devices. Motion sensor(s) may be used to facilitate movement and orientation related functions of subsystem 101, for example, to detect movement, direction, and/or orientation of subsystem 101. While specific examples are provided, it should be appreciated that other sensors can be used and other combinations of sensors can be combined into a single subsystem 101. Using one or more of these sensors, subsystem 101 can determine physiological characteristics of the user while performing a detected activity, such as a heart rate of a user associated with the detected activity, average body temperature of a user detected during the detected activity, any normal or abnormal physical conditions associated with the detected activity, or the like. In some examples, a GPS sensor or any other suitable location detection component(s) or positioning circuitry (“PC”) (e.g., PC 15a) of sensor 15 of subsystem 101 can be used to determine a user's location (e.g., geo-location and/or address and/or location type (e.g., library, school, office, zoo, etc.)) and movement, as well as a displacement of the user's motion. Any suitable positioning circuitry 15a may be used in determining the location of subsystem 101 based on positioning technology. For example, positioning circuitry 15a may provide for one or more of GNSS positioning (e.g., via a GNSS receiver configured of subsystem 101 to receive signals from GNSS satellites (e.g., of a distinct navigation subsystem 104)), wireless access point positioning (e.g., via a wireless network receiver configured to receive signals from wireless access points (e.g., of a distinct navigation subsystem 104 or network 108)), cellular phone signal positioning, Bluetooth signal positioning (e.g., via a Bluetooth receiver), image recognition positioning (e.g., via an image sensor), and/or an INS (e.g., via motion sensors, such as an accelerometer and/or gyroscope). Positioning circuitry 15a may correspond to or otherwise be part of a localization system of subsystem 101 (e.g., motion capture system, GPS, RTK GPS, electromagnetic tracking system, inertial, ultra-sonic system, ultra-wideband locating system, visual marker/marker-less tracking, visual odometry, GPS-Inertial Odometry, Visual-Inertial Odometry, LiDAR system, sonar system, iBeacon/Tag, SLAM, SfM, Wi-Fi localization, and/or the like). An accelerometer, directional sensor, and/or gyroscope (e.g., rate gyroscope) of sensor 15 can further generate activity data that can be used to determine whether a user of subsystem 101 is engaging in an activity, is inactive, or is performing a gesture. Any suitable activity of a user may be tracked by sensor 15, including, but not limited to, steps taken, flights of stairs climbed, distance walked, distance run, minutes of exercise performed and exercise quality, any suitable work accomplishments of any suitable type (e.g., as may be sensed or logged by user input information indicative of such accomplishments), and/or the like. Subsystem 101 can further include a timer that can be used, for example, to add time dimensions to various attributes of the detected physical activity, such as a duration of a user's physical activity or inactivity, time(s) of a day when the activity is detected or not detected, and/or the like. Sensor 15 may include any suitable sensor components or subassemblies for detecting any suitable characteristics of any suitable condition of the lighting of the environment of subsystem 101. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 101 (e.g., in lux or lumens per square meter, etc.) and/or for determining the ambient color or white point chromaticity of ambient light in the environment of subsystem 101 (e.g., in hue and colorfulness or in x/y parameters with respect to an x-y chromaticity space, etc.) and/or for determining the UV index or UV radiation in the environment of subsystem 101 (e.g., in UV index units, etc.). A suitable light sensor may include, for example, a photodiode, a phototransistor, an integrated photodiode and amplifier, or any other suitable photo-sensitive device. In some embodiments, more than one light sensor may be integrated into subsystem 101. Sensor 15 may include any suitable sensor components or subassemblies for detecting any suitable characteristics of any suitable condition of the air quality of the environment of subsystem 101. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 101 (e.g., in O₂ % per liter, etc.) and/or for determining the air velocity of the ambient air in the environment of subsystem 101 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 101 (e.g., in HG % per liter, etc.) and/or for determining the humidity of the ambient air in the environment of subsystem 101 (e.g., in grams of water per cubic meter, etc. (e.g., using a hygrometer)) and/or for determining the temperature of the ambient air in the environment of subsystem 101 (e.g., in degrees Celsius, etc. (e.g., using a thermometer)). Sensor 15 may include any suitable sensor components or subassemblies for detecting any suitable characteristics of any suitable condition of the sound quality of the environment of subsystem 101. For example, sensor 15 may include any suitable sound quality sensor that may include, but is not limited to, one or more microphones or the like that may determine the level of sound pollution or noise in the environment of subsystem 101 (e.g., in decibels, etc.). Sensor 15 may also include any other suitable sensor for determining any other suitable characteristics about a user of subsystem 101 and/or the environment of subsystem 101 and/or any situation within which subsystem 101 may be existing. For example, any suitable clock and/or position sensor(s) may be provided to determine the current time and/or time zone within which subsystem 101 may be located. Sensor 15 may be embedded in a structure or body (e.g., housing 11) of subsystem 101, such as along a bottom surface that may be operative to contact a user, or can be positioned at any other desirable location. In some examples, different sensors can be placed in different locations inside or on the surfaces of subsystem 101 (e.g., some located inside housing 11 and some attached to an attachment mechanism (e.g., a wrist band coupled to a housing of a wearable device), or the like). In other examples, one or more sensors can be worn by a user separately as different parts of a single subsystem 101 or as different devices. In such cases, the sensors can be configured to communicate with subsystem 101 using a wired and/or wireless technology (e.g., via communications component 14). In some examples, sensors can be configured to communicate with each other and/or share data collected from one or more sensors. In some examples, subsystem 101 can be waterproof such that the sensors can detect a user's or subsystem's activity in water.

Power supply 17 can include any suitable circuitry for receiving and/or generating power, and for providing such power to one or more of the other components of subsystem 101. For example, power supply assembly 17 can be coupled to a power grid (e.g., when subsystem 101 is not acting as a portable device or when a battery of the subsystem is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 101 is acting as a portable device). Subsystem 101 may also be provided with a housing 11 that may at least partially enclose one or more of the components of subsystem 101 for protection from debris and other degrading forces external to subsystem 101. Each component of subsystem 101 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 101 may include other components not combined or included in those shown or several instances of the components shown.

Processor 12 may be used to run one or more applications, such as an application 19 (e.g., a specific OCS protocol application 19a, etc.) that may be accessible from memory 13 (e.g., as a portion of data 19d) and/or any other suitable source (e.g., from network 108 or any other subsystem and an active internet or other suitable data connection or channel 103 or channel 107, etc.). Application 19 may include, but is not limited to, one or more operating system applications, firmware applications, communication applications (e.g., for enabling communication of data between subsystems 101), third party service applications (e.g., wallet applications, sensor applications, social media applications, etc.), internet browsing applications (e.g., for interacting with a website provided by a third party subsystem or other subsystem for enabling subsystem 101 to interact with an online service), application programming interfaces (“APIs”), software development kits (“SDKs”), OCS applications (e.g., a web application or a native application that may be at least partially produced by OCS subsystem 106 or otherwise for enabling subsystem 101 to communicate with another subsystem (e.g., to enable two communication subsystems to communicate with an OCS protocol)), and/or any other suitable applications (e.g., an LPS application). For example, processor 12 may load an application 19 as a user interface program to determine how instructions or data received via an input component 16i of I/O component 16 or other component of subsystem 101 (e.g., sensor 15 and/or communications component 14) may manipulate the way in which information may be stored (e.g., in memory 13) and/or provided to the user or another subsystem via an output component 16o of I/O component 16 and/or to via communications component 14. As one example, application 19 may provide subsystem 101 with the ability to interact with an OCS platform of system 1, where application 19 may be a third party application that may be running on subsystem 101 (e.g., an application associated with OCS subsystem 106 and/or a third party subsystem or the like) that may be loaded on subsystem 101 (e.g., using communications component 14) via an application market, such as the Apple App Store or Google Play, or that may be accessed via an internet application or web browser (e.g., by Apple Safari or Google Chrome) that may be running on subsystem 101 and that may be pointed to a uniform resource locator (“URL”) whose target or web resource may be managed by or otherwise affiliated with the OCSP. Processor 12 may include suitable logic, circuitry, and/or code that may enable processing data and/or controlling operations of subsystem 101. In this regard, processor 12 may be enabled to provide control signals to various other components of subsystem 101. Processor 12 may also control transfers of data between various portions of subsystem 101. Processor 12 may further implement an operating system or may otherwise execute code to manage operations of subsystem 101.

Subsystem 101 may be configured to have any physical structure (e.g., by one or more housings 11) that may include, but is not limited to, any suitable portable, mobile, wearable, implantable, rideable, controllable, or hand-held mobile electronic device (e.g., a portable telephone and/or handheld media player), a headset, a helmet, glasses, a tablet computer, a laptop computer, a spatial tracking system, a controller, a VR and/or AR and/or MR device, a ring, a necklace, an augmented reality device, a mixed reality device, an unmanned or autonomous vehicle (“AV”), an aerial vehicle (e.g., an aerial AV), an airplane, a helicopter, a drone (e.g., a multirotor drone), a terrain vehicle, an aquatic vehicle, a hover vehicle, any combination thereof, and/or any other machine or device or housing or structure that can be utilized to travel within an environment (e.g., for mapping or localizing its location and/or orientation within the environment). Alternatively, subsystem 101 may not be portable during use, but may instead be generally stationary (e.g., as a type of OCS subsystem 106 or a non-mobile type of communication subsystem 100). Subsystem 101 can include, but is not limited to, a vehicle, media player, video player, still image player, game player, other media player, music recorder, movie or video camera or recorder, still camera, other media recorder, radio, medical equipment, domestic appliance, smart appliance, transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., watch, ring, glasses, etc.), boom box, internet of things (“IoT”) device, virtualized IoT device (e.g., cloud compute instance), modem, router, RFID card, printer, kiosk, beacon (e.g., a Bluetooth low energy beacon transmitter device), any combinations thereof, and/or the like. Not all of the depicted components may be used in all implementations, however, and one or more implementations may include additional or different components than those shown in FIG. 1A. In one or more implementations, one or more of processor 12, memory 13, sensor(s) 15, PC 15a, communications interface or communications component 14, I/O component 16, and/or power supply 17, and/or one or more portions thereof, may be implemented in software (e.g., subroutines and code), may be implemented in hardware (e.g., an application specific integrated circuit (“ASIC”), a field programmable gate array (“FPGA”), a programmable logic device (“PLD”), a controller, a state machine, gated logic, discrete hardware components, or any other suitable devices), and/or a combination of both. Variations in the arrangement and type of the components may be made without departing from the spirit or scope of the claims as set forth herein. Additional components, different components, or fewer components may be provided.

As shown in FIGS. 1B and 1C, a particular embodiment of system 1 may include each one of communication subsystems 100a-100d being identical or substantially identical multi-rotor drones that may be configured (e.g., by OCS subsystem 106) with any suitable OCS protocol and any suitable OCS components. For example, each drone communication subsystem may include any suitable number of rod OCS components, such as four rod OCS components 16c-1, 16c-2, 16c-3, and 16c-4, where each may be controlled by its own output component 16o (e.g., output component 16oc-1 for controlling OCS component 16c-1, output component 16oc-2 for controlling OCS component 16c-2, etc.), and/or where each may have its own characteristic changing portion 16ct (e.g., characteristic changing portion 16ct-1 of OCS component 16c-1, characteristic changing portion 16ct-2 of OCS component 16c-2, characteristic changing portion 16ct-3 of OCS component 16c-2, and characteristic changing portion 16ct-4 of OCS component 16c-4) that may be configured to have its color, shape, temperature, and/or any other suitable characteristic adjusted (e.g., over time) in any suitable manner (e.g., using an associated output component 16oc). As shown, each rod OCS component may be positioned on a top of the drone's main vehicle body 11 (e.g., above each of the rotor's blades 16r-1 to 16r-4, where the direction and speed of each rotor blade 16r may be independently controlled by independent rotor output components 16or (e.g., components 16or-1, 16or-2, 16or-3, 16or-4) for controlling the overall movement of the communication subsystem (e.g., housing 11) for each of the six degrees of freedom). Although, this is only illustrative, and any other suitable configuration of OCS component(s) and output component(s) may be provided at any suitable location(s) along any suitable portion(s) of any suitable type of communication subsystem. Regardless of any direction in which the drone may be traveling (e.g., in X-Y-Z space) or if the drone is still, an OCS protocol may be configured to dictate some overall movement (e.g., jiggle, shake, quickly hop up and down along an axis, quickly rotate about an axis, etc.) of a drone communication subsystem (e.g., a communication subsystem acting as a transmitting communication subsystem (e.g., using any suitable output component(s) 16)) and/or some movement of certain OCS component(s) relative to other OCS component(s) of the drone communication subsystem (e.g., a communication subsystem acting as a transmitting communication subsystem (e.g., using any suitable output component(s) 16)) and/or some color change, shape change, temperature change, and/or any other suitable characteristic change of certain OCS component(s) of the drone communication subsystem (e.g., a communication subsystem acting as a transmitting communication subsystem (e.g., using any suitable output component(s) 16)) and/or the like that may be detectable as any suitable signal(s) 105 via any suitable channel 103 by another communication subsystem (e.g., a communication subsystem acting as a receiving communication subsystem (e.g., using any suitable sensor(s) 15)) and then used to look-up a pre-defined intended message associated with that detected reconfiguration of the transmitting communication subsystem.

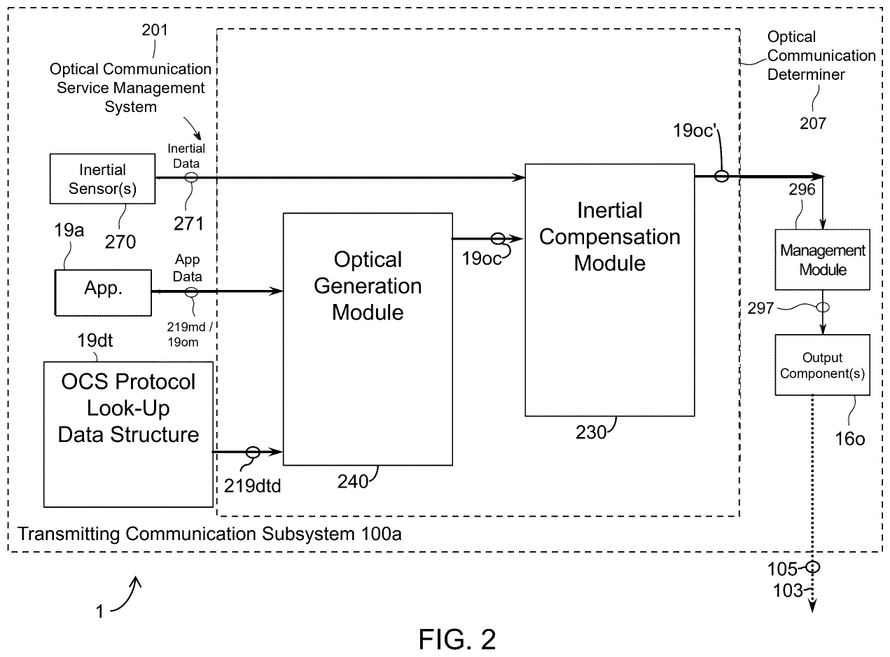

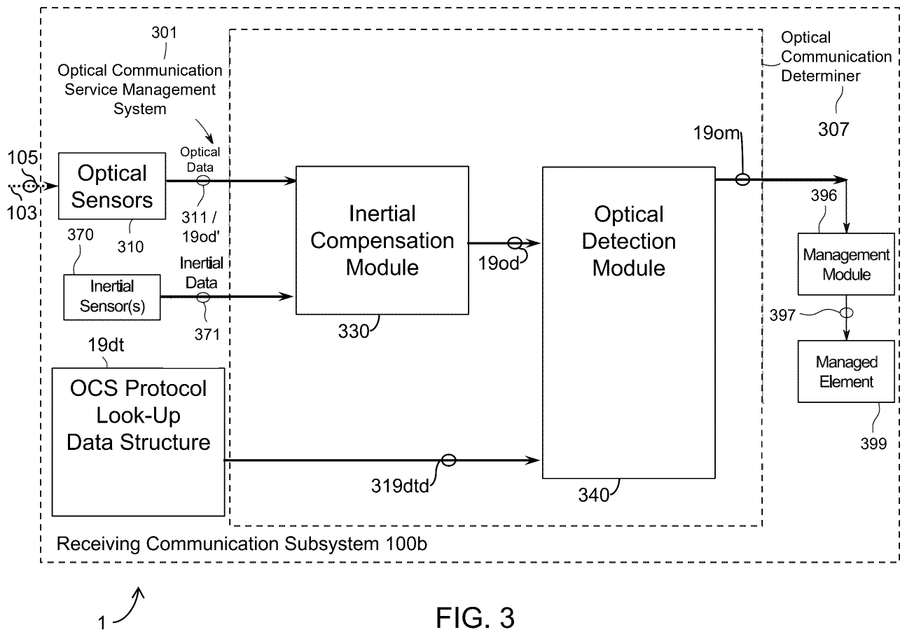

For example, as shown in FIG. 1D, any suitable OCS protocol look-up table or OCS protocol look-up data or other suitable data structure 19dt (e.g., any suitable data 19d of one, some, or all communication subsystems 100) may be defined to associate at least one particular message 19om with at least one particular optical detection 19od and/or with at least one optical configuration 19oc. In particular, as shown, a first OCS protocol entry 19p1 may associate a first particular message 19om of <message_1> with a first particular optical detection 19od of <detection(s)_1> and with a first particular optical configuration 19oc of <configuration(s)_1>, a second OCS protocol entry 19p2 may associate a second particular message 19om of <message_2> with a second particular optical detection 19od of <detection(s)_2> and with a second particular optical configuration 19oc of <configuration(s)_2>, and so on up to an Nth OCS protocol entry 19pN that may associate an Nth particular message 19om of <message_N> with an Nth particular optical detection 19od of <detection(s)_N> and with an Nth particular optical configuration 19oc of <configuration(s)_N>. Each particular message 19om of a particular OCS protocol entry 19p may define a particular message to be communicated by the OCS protocol from one communication subsystem to another via any suitable signal(s) 105 via a channel 103, where each message may be related to any suitable information or instruction or the like (e.g., <message_1> of OCS protocol entry 19p1 may be indicative of a status of the communication subsystem (e.g., “the communication subsystem making this communication has a low battery and must soon return to home base” or “the communication subsystem making this communication has identified the target and is in pursuit”), <message_2> of OCS protocol entry 19p2 may be indicative of a request of the communication subsystem (e.g., “the communication subsystem making this communication wants to know the status of the communication subsystem receiving this communication”), <message_N> of OCS protocol entry 19pN may be indicative of a status of another communication subsystem (e.g., “the communication subsystem making this communication knows that a communication subsystem different from the two communication subsystems currently communicating has a low battery and must soon return to home base”), and/or the like). Each particular optical detection 19od of a particular OCS protocol entry 19p may define a particular optical detection to be made by a communication subsystem (e.g., a communication subsystem acting as a receiving communication subsystem) from any suitable signal(s) 105 communicated by another communication subsystem (e.g., a communication subsystem acting as a transmitting communication subsystem) via a channel 103 for enabling the receiving communication subsystem to identify the particular message 19om of that particular OCS protocol entry 19p, where each optical detection 19od may be related to any suitable state change in movement, temperature, color, shape, and/or the like of the transmitting communication subsystem (e.g., <detection(s)_1> may be indicative of a jitter movement of the transmitting communication subsystem (e.g., “detect that a quick repeated pattern of up and down movement along the Z-axis has been made by the entire transmitting communication subsystem”), <detection(s)_2> may be indicative of a first movement of a first OCS component relative to a second OCS component of the transmitting communication subsystem (e.g., “detect that a first rod OCS component of the transmitting communication subsystem has been rotated out from a parallel position relative to a second rod OCS component of the transmitting communication subsystem to a skew position relative to the second rod OCS component” (e.g., as may be shown by the change in configuration of at least rod OCS component 16c-1 relative to rod OCS component 16c-4 from that of FIG. 1B to that of FIG. 1C for transmitting communication subsystem 100a)), <detection(s)_N> may be indicative of a first change in any suitable characteristic (e.g., temperature or color or shape or the like) of a first OCS component relative to a second OCS component of the transmitting communication subsystem (e.g., “detect that a first rod OCS component of the transmitting communication subsystem has been heated up from the same temperature as a second rod OCS component of the transmitting communication subsystem to a temperature twice as hot as the second rod OCS component in a 5 second period of time” (e.g., as may be shown by a change in characteristic changing portion 16ct-4 but not in characteristic changing portion 16ct-1 between the configuration of FIG. 1B and the configuration of FIG. 1C for transmitting communication subsystem 100a)), and/or the like). Each particular optical configuration 19oc of a particular OCS protocol entry 19p may define a particular optical configuration to be achieved (e.g., a particular reconfiguration to be carried out) by a communication subsystem (e.g., a communication subsystem acting as a transmitting communication subsystem) for generating any suitable signal(s) 105 to be communicated to another communication subsystem (e.g., a communication subsystem acting as a receiving communication subsystem) via a channel 103 for identifying the particular message 19om of that particular OCS protocol entry 19p, where each optical configuration 19oc may be related to any suitable movement, temperature, color, and/or the like of the transmitting communication subsystem (e.g., <configuration(s)_1> may be indicative of a jitter movement to be made by the transmitting communication subsystem (e.g., “make a quick repeated pattern of up and down movement of this entire subsystem along the Z-axis”), <configuration(s)_2> may be indicative of a first movement of a first OCS component relative to a second OCS component of the transmitting communication subsystem (e.g., “rotate a first rod OCS component of this transmitting communication subsystem out from a linear position relative to a second rod OCS component of this transmitting communication subsystem to a perpendicular position relative to the second rod OCS component”), <communication_N> may be indicative of a first change in any suitable characteristic (e.g., temperature or color or shape or the like) of a first OCS component relative to a second OCS component of the transmitting communication subsystem (e.g., “heat up a first rod OCS component of this transmitting communication subsystem from the same temperature as a second rod OCS component of this transmitting communication subsystem to a temperature twice as hot as the second rod OCS component in a 5 second period of time”), and/or the like). When each one of a communication subsystem 100 acting as a transmitting communication subsystem and another communication subsystem 100 acting as a receiving communication subsystem with a common channel 103 have access to the same or overlapping OCS protocol look-up data or data structure 19dt (e.g., each communication subsystem 100 has the same or similar data structure 19dt stored thereon (e.g., each data structure may share at least one or more common OCS protocol entries 19p), they may be configured to use the common OCS protocol to communicate one or more pre-defined messages using commonly-associated optical detection(s) and optical configuration(s) of one or more common OCS protocol entries 19p. Any suitable application 19a running on a transmitting communication subsystem 100 may be configured to determine an appropriate message 19om of a particular OCS protocol entry 19p to be communicated based on any suitable processing carried out by that transmitting communication subsystem (e.g., determining that its battery is low, determining that it wants a status update of a receiving communication subsystem, determining that it needs to relay or share the status of a third communication subsystem, etc.) and then to identify the associated optical configuration 19oc of that particular OCS protocol entry 19p and then to execute that optical configuration 19oc using any suitable output component(s) 16o or otherwise of that transmitting communication subsystem for enabling suitable optical detection of that optical configuration via a channel 103 as any suitable signal(s) 105 by any suitable receiving communication subsystem (see, e.g., FIG. 2). Any suitable application 19a running on a receiving communication subsystem 100 may be configured to determine an appropriate message 19om of a particular OCS protocol entry 19p to be processed based on any suitable optical detection(s) 19od made by that receiving communication subsystem (see, e.g., FIG. 3) in response to detecting via a channel 103 as any suitable signal(s) 105 from a transmitting communication subsystem and then using that determined appropriate message 19om to initiate any suitable action by the receiving communication subsystem 100 (e.g., follow the transmitting communication subsystem back to base while it recharges its battery, send the transmitting communication subsystem a requested status, etc.).

FIG. 2 shows a schematic view of an exemplary optical communication service management system (“OCSMS”) 201 of system 1 that may be provided to manage any suitable optical communication services for any suitable transmitting communication subsystem 100a (e.g., any suitable communication subsystem 100 acting as a transmitting communication subsystem), such as to identify and execute a particular optical configuration 19oc of a particular OCS protocol entry 19p based on any suitable message 19om (e.g., as may be chosen by any suitable application 19a of that transmitting communication subsystem) using any suitable output component(s) 16o of that transmitting communication subsystem for generating any suitable optical signal(s) 105 that may be communicated via communication channel 103 for detection by another communication subsystem 100 acting as a receiving communication subsystem (see, e.g., subsystem 100b of FIG. 3)). OCSMS 201 may be configured to generate, receive, obtain, and/or otherwise use any suitable data, including, but not limited to, any suitable inertial data 271 (e.g., estimated orientation data) that may be generated by any suitable proprioceptive sensor(s) and/or inertial sensor(s) 270 (e.g., any suitable orientation sensor(s) or attitude and heading reference system (“AHRS”) sensor(s) (e.g., any suitable inertial or orientation sensor(s) 15)) of transmitting communication subsystem 100a, any suitable application message data 219md (e.g., data including or otherwise identifying any suitable message 19om) that may be generated by any suitable application 19a (e.g., a particular OCS protocol application (e.g., as may be provided by OCS subsystem 106)) that may be running on transmitting communication subsystem 100a (e.g., using any suitable processor 12) based on any suitable information that may be available to be processed by transmitting communication subsystem 100a (e.g., battery charge level or any other suitable status of transmitting subsystem 100a, accessible status information of another communication subsystem (e.g., subsystem 100c) to be relayed, a need for status information of another communication subsystem (e.g., subsystem 100b), and/or the like), any suitable OCS protocol look-up data 219dtd that may be generated or provided by any suitable subsystem(s) of system 1 (e.g., by any suitable OCS protocol look-up data structure 19dt stored on (e.g., in memory 13) or otherwise available to transmitting communication subsystem 100a (e.g., as may be provided by OCS subsystem 106)), and/or the like. OCSMS 201 of transmitting communication subsystem 100a may include an optical communication determiner module 207 that may be configured to process (e.g., using any suitable models (e.g., model(s) 19m), algorithms, and/or the like) app data 219md and associated inertial data 271 in conjunction with any suitable OCS protocol look-up data 219dtd to determine an appropriate optical configuration 19oc′ to be executed (e.g., to be executed using any suitable output component(s) 16o or otherwise of that transmitting communication subsystem for enabling any suitable optical detection of that executed optical configuration via a channel 103 as any suitable signal(s) 105 by any suitable receiving communication subsystem (see, e.g., receiving communication subsystem 100 of FIG. 3)). In response to determining the appropriate optical configuration 19oc′ to be executed, OCSMS 201 may be configured to apply at least one optical communication-based mode of operation to one or more appropriate output component(s) 16o (e.g., any suitable lighting output component(s), shape-shifting output component(s), movement actuator(s), heat/cooling actuator(s), haptic component(s), component(s) 16oc, component(s) 16or, and/or the like for providing any suitable optical communication configurations) based on the determined appropriate optical configuration 19oc′ for enabling the optical communication of message 19om of data 219md. For example, as shown in FIG. 2, OCSMS 201 may include a management module 296 for receiving data indicative of appropriate optical configuration 19oc′ and providing appropriate output component reconfiguration instruction data 297 to be executed by appropriate output component(s) 16o for generating acceptable signal(s) 105.

Optical communication determiner module 207 may include any suitable optical generation module 240 that may be configured to process (e.g., using any suitable models (e.g., model(s) 19om), algorithms, and/or the like) any suitable app data 219md and any accessible OCS protocol look-up data 219dtd to surface any appropriate optical configuration 19oc. For example, optical generation module 240 may be configured to process app data 219md to identify an appropriate particular message 19om of a particular OCS protocol entry 19p of OCS protocol look-up data structure 19dt (e.g., a particular one of <message_1> message 19om of entry 19p1, <message_2> message 19om of entry 19p2, or <message_N> message 19om of entry 19pN) and then identify a particular optical configuration 19oc of the particular OCS protocol entry 19p that includes the identified particular message 19om (e.g., a particular one of <configuration(s)_1> optical configuration 19oc of entry 19p1, <configuration(s)_2> optical configuration 19oc of entry 19p2, or <configuration(s)_N> optical configuration 19oc of entry 19pN) in order to provide that identified particular optical configuration 19oc as the output of optical generation module 240.

Optical communication determiner module 207 may also include any suitable inertial compensation module 230 that may be configured to process (e.g., using any suitable models (e.g., model(s) 19m), algorithms, and/or the like) the identified particular optical configuration 19oc as output by optical generation module 240 and any suitable associated inertial data 271 to generate any suitable compensated or updated optical configuration 19oc′ (e.g., for use by management module 296 and output component(s) 16o). Inertia or orientation data 271 may be any suitable data indicative of the orientation of transmitting communication subsystem 100a and/or of one or more of its output components 16o at any moment in time (e.g., a current moment in time) with respect to any suitable reference frame (e.g., NED reference frame or any other suitable world reference frame) and may be generated by any suitable number of any suitable type(s) of orientation or inertial sensor(s) 270. Such inertial or orientation data 271 may be used by module 230 for adjusting the instructions of optical configuration 19oc to generate the instructions of optical configuration 19oc′ that may be configured to compensate for the current orientation of device 100a and/or of any output component(s) 16o thereof. Such compensation may enable the signal(s) 105 as provided by output component(s) 16o based on the instructions of optical configuration 19oc′ to be detected successfully by a receiving communication subsystem making an optical detection defined by the optical detection 19od of the same OCS protocol entry 19p used to surface the particular optical configuration 19oc provided as input to module 230. For example, while a particular optical configuration 19oc of a particular OCS protocol entry 19p may be configured (e.g., by OCS subsystem 106) to instruct a transmitting communication subsystem's output component(s) 16o to generate signal(s) 105 that may be detected successfully by a receiving communication subsystem making an optical detection defined by the optical detection 19od of the same particular OCS protocol entry 19p when both the transmitting communication subsystem 100a and the receiving communication subsystem 100b (and any suitable ones of their output component(s) and/or optical sensor(s)) are at a particular reference orientation or have the same particular reference attitude relative to a reference control frame of any suitable world reference frame, such a particular optical configuration 19oc may be compensated in any suitable manner to provide compensated optical configuration 19oc′ when the current orientation of transmitting communication subsystem 100a and/or any of its output component(s) 16o is different than such a reference orientation. This may be accomplished using any suitable models that may be trained using any suitable training data accessible to OCS subsystem 106 and then provided to communication subsystem 100's inertial compensation module (e.g., as a model 19m) for enabling the prediction or other suitable generation of compensated optical configuration 19oc′ using optical configuration 19oc from module 240 and inertial data 271 as model inputs (see, e.g., U.S. Pat. No. 12,366,459, which is hereby incorporated by reference herein in its entirety). Alternatively, in some embodiments, module 230 may not be used and the particular optical configuration 19oc output by module 240 may be provided directly to management module 296 for use in instructing the reconfiguration of one or more output components 16o.

FIG. 3 shows a schematic view of an exemplary optical communication service management system (“OCSMS”) 301 of system 1 that may be provided to manage optical communication services for any suitable receiving communication subsystem 100b (e.g., any suitable communication subsystem 100 acting as a receiving communication subsystem), such as to determine a relevant message 19om from any suitable communicated optical signal(s) 105 that may be detected via communication channel 103 by any suitable component(s) (e.g., optical sensor(s) 310 (e.g., any suitable sensor(s) 15)) of that receiving communication subsystem 100b from another communication subsystem 100 acting as a transmitting communication subsystem (see, e.g., subsystem 100a of FIG. 2) and/or to manage a mode of operation of that receiving communication subsystem 100b and/or of any other suitable subsystem of system 1 based on the determined message 19om). It is to be understood that any suitable communication subsystem 100 may include both a transmitting OCSMS 201 and a receiving OCSMS 301 (or both such systems may be provided by a single combined OCSM system) in order for that communication subsystem 100 to be enabled to function as both a transmitting communication subsystem and a receiving communication subsystem (e.g., simultaneously for carrying out two distinct communications or in an alternating fashion). Alternatively, in some embodiments, a certain communication subsystem 100 may include only OCSMS 201 if that subsystem 100 is only to be configured as a transmitting communication subsystem or only OCSMS 301 if that subsystem 100 is only to be configured as a receiving communication subsystem.

OCSMS 301 may be configured to generate, receive, obtain, and/or otherwise use any suitable data, including, but not limited to, any suitable optical data 311 (e.g., any suitable image data (e.g., query images, input images, full motion video (“FMV”) images, etc.), any suitable motion capture sensing data, any suitable infrared sensor data, any suitable thermal image data, and/or the like) that may be generated by any suitable camera(s) or image sensor(s) or heat sensor(s) or motion capture sensor(s) or other suitable optical sensor(s) 310 (e.g., any suitable sensor(s) 15) of receiving communication subsystem 100b (e.g., based on detecting and processing any suitable optical signal(s) 105 via a channel 103 that may be indicative of any suitable output component(s) 16o of any suitable transmitting communication subsystem 100a executing any suitable optical configuration 19oc or compensated optical configuration 19oc′ (see, e.g., FIG. 2)), any suitable inertial data 371 (e.g., estimated orientation data) that may be generated by any suitable proprioceptive sensor(s) and/or inertial sensor(s) 370 (e.g., any suitable orientation sensor(s) or attitude and heading reference system (“AHRS”) sensor(s) (e.g., any suitable inertial or orientation sensor(s) 15)) of receiving communication subsystem 100b, any suitable OCS protocol look-up data 319dtd that may be generated or provided by any suitable subsystem(s) of system 1 (e.g., by any suitable OCS protocol look-up data structure 19dt stored on (e.g., in memory 13) or otherwise available to receiving communication subsystem 100b (e.g., as may be provided by OCS subsystem 106)), and/or the like. OCSMS 301 of receiving communication subsystem 100b may include an optical communication determiner module 307 that may be configured to process (e.g., using any suitable models (e.g., model(s) 19m), algorithms, and/or the like) optical data 311 and associated inertial data 371 in conjunction with any suitable OCS protocol look-up data 319dtd to determine an appropriate optical message 19om to be used by the receiving communication subsystem in any suitable manner (e.g., to apply at least one optical communication-based mode of operation to at least one managed element 399 (e.g., any suitable assembly of any suitable subsystem of system 1 (e.g., any suitable component of receiving communication subsystem 100b)) based on the determined optical message 19om (e.g., to suggest certain user behavior and/or to control the functionality of one or more system assemblies) for improving a user's experience). For example, as shown in FIG. 3, OCSMS 301 may include a management module 396 for receiving optical message 19om and providing optical communication mode data 397 to managed element 399.

Optical communication determiner module 307 may include any suitable inertial compensation module 330 that may be configured to process (e.g., using any suitable models (e.g., model(s) 19m), algorithms, and/or the like) any suitable associated inertial data 371 and any suitable optical data 311 that may be indicative of any suitable detected optical detection 19od′ of a transmitting communication subsystem (e.g., as may be generated by optical sensor(s) 310 based on any suitable detected signal(s) 105) to generate any suitable compensated optical detection 19od (e.g., for use by an optical detection module). Inertia or orientation data 371 may be any suitable data indicative of the orientation of receiving communication subsystem 100b and/or of one or more of its optical sensors 310 at any moment in time (e.g., a current moment in time) with respect to any suitable reference frame (e.g., NED reference frame or any other suitable world reference frame) and may be generated by any suitable number of any suitable type(s) of orientation or inertial sensor(s) 370. Such inertial or orientation data 371 may be used by module 330 for adjusting the optical detection defined by detected optical detection 19od′ to generate compensated optical detection defined by compensated optical detection 19od that may be configured to compensate for the current orientation of device 100b and/or of any optical sensor(s) 310 thereof. Such compensation may enable the compensated optical detection 19od to be identified in an OCS protocol entry 19p that may also include the particular optical message 19om used by optical generation module 240 of the transmitting communication subsystem 100a in order to generate the signal(s) 105 (see, e.g., FIG. 2). For example, while a particular optical detection 19od of a particular OCS protocol entry 19p may be configured (e.g., by OCS subsystem 106) to identify a particular optical detection to be made by a receiving communication subsystem's optical sensor(s) 310 in response to detecting successfully signal(s) 105 generated by a transmitting communication subsystem's output component(s) 16o based on the particular optical configuration 19oc of the same particular OCS protocol entry 19p when both the transmitting communication subsystem 100a and the receiving communication subsystem 100b (and any suitable ones of their output component(s) and/or optical sensor(s)) are at a particular reference orientation or have the same particular reference attitude relative to a reference control frame of any suitable world reference frame, such a particular optical detection 19od affected in any suitable manner to provide detected optical detection 19od′ when the current orientation of receiving communication subsystem 100b and/or any of its optical sensor(s) 310 is different than such a reference orientation. This may be accomplished using any suitable models that may be trained using any suitable training data accessible to OCS subsystem 106 and then provided to communication subsystem 100's inertial compensation module (e.g., as a model 19m) for enabling the prediction or other suitable generation of compensated optical detection 19od using detected optical detection 19od′ of data 311 and inertial data 371 as model inputs (see, e.g., U.S. Pat. No. 12,366,459, which is hereby incorporated by reference herein in its entirety). Alternatively, in some embodiments, module 330 may not be used and the particular optical detection 19od′ output by optical sensor(s) 310 may be provided directly to optical detection module 340 for use in identifying an appropriate OCS protocol entry 19p.

Optical communication determiner module 307 may also include any suitable optical detection module 340 that may be configured to process (e.g., using any suitable models (e.g., model(s) 19m), algorithms, and/or the like) any suitable optical detection 19od provided by module 330 (or optical detection 19od′ provided directly by optical sensor(s) 310) and any accessible OCS protocol look-up data 319dtd to surface any appropriate optical message 19om. For example, optical detection module 340 may be configured to process OCS protocol look-up data 319dtd to identify a particular OCS protocol entry 19p of OCS protocol look-up data structure 19dt that includes the received optical detection 19od (e.g., a particular one of <detection(s)_1> detection 19od of entry 19p1, <detection(s)_2> detection 19od of entry 19p2, or <detection(s)_N> detection 19od of entry 19pN) and then identify a particular message 19om of the particular OCS protocol entry 19p that includes the received optical detection 19od (e.g., a particular one of <message_1> message 19om of entry 19p1, <message_2> message 19om of entry 19p2, or <message_N> message 19om of entry 19pN) in order to provide that identified particular message 19om as the output of optical detection module 340.

Once optical communication determiner module 307 has identified a particular message 19om (e.g., based on any suitable combination of optical data 311 and associated inertial data 371 and any suitable OCS protocol look-up data 319dtd), optical communication determiner module 307 may be configured to generate and transmit that identified particular message 19om to management module 396, where identified particular message 19om may be indicative of the determined message intended to be conveyed via the optical communication by transmitting communication subsystem 100a to receiving communication subsystem 100b per any suitable OCS protocol of system 1. In response to determining particular message 19om, management module 396 may be configured to apply at least one optical communication-based mode of operation to at least one managed element 399 of system 1 (e.g., any suitable element of receiving communication subsystem 100b) based on the determined particular message 19om. For example, as shown in FIG. 3, management module 396 may be configured to particular message 19om from determiner 307 as well as to generate and share optical communication-based mode data 397 with at least one managed element 399 of system 1 at least partially based on the particular message 19om, where such data 397 may be received by managed element 399 for controlling at least one characteristic of managed element 399. Managed element 399 may be any suitable assembly of receiving communication subsystem 100b (e.g., any processor assembly 12, any memory assembly 13 and/or any data stored thereon, any communications assembly 14, any power supply assembly 17, any input and/or output assembly 16, any sensor assembly 15, etc.) and/or any suitable assembly of any suitable other subsystem of system 1, and data 397 may control managed element 399 in any suitable way, such as by providing, enhancing, enabling, disabling, restricting, and/or limiting one or more certain functionalities associated with such a managed element.

Optical communication-based mode data 397 may be any suitable subsystem control data for controlling any suitable functionality of any suitable assembly of subsystem 100b as a managed element 399 (e.g., any suitable subsystem output control data for controlling any suitable functionality of any suitable output assembly of subsystem 100b (e.g., for adjusting a user interface presentation to user), and/or any suitable subsystem sensor control data for controlling any suitable functionality of any suitable sensor 15 of subsystem 100b (e.g., for turning on or off a particular type of sensor and/or for adjusting the functionality (e.g., the accuracy) of a particular type of sensor (e.g., to gather any additional suitable sensor data)), and/or any suitable activity application control for updating or supplementing any input data available to any application that may be running on subsystem 100b (e.g., for controlling one or more functionalities of determiner 307 and/or for controlling a flight path of subsystem 100b or future communications made by subsystem 100b, etc.), and/or the like). Additionally or alternatively, optical communication-based mode data 397 may be any suitable auxiliary subsystem data for controlling any suitable functionality of any suitable auxiliary subsystem of system 1 as a managed element 399 (e.g., for controlling a functionality of an OCS subsystem 106 (e.g., for controlling any suitable functionality of a model generator or trainer or the like)). Data 397 may be used by any suitable managed element(s) 399, including, but not limited to, VR and/or AR and/or MR use cases (e.g., for navigation and/or mission planning/control), scene agent reconstruction (e.g., a map match approach), change detection (e.g., comparing existing map(s) at the estimated pose with saved map(s) and determine alterations on the landscape), and/or the like.

Therefore, optical communication between any suitable transmitting communication subsystem 100a and any suitable receiving communication subsystem 100b, each of which may be at any suitable orientation, may be totally passive, may not be spoofed, may not be jammed, and may not use any network connection, but rather each communication subsystem may use pre-stored on-board data (e.g., database(s) 19dt) and data generated on-board the communication subsystem when it is to conduct such communication (e.g., application data, image sensor data, inertial data, etc.). This may be an effective and efficient and secure alternative to RF communication between subsystems (e.g., using any suitable network 108).

This disclosure provides a vision-based approach to facilitate passive communication between multiple autonomous vehicles (“AVs”) (e.g., intelligence, surveillance, reconnaissance (“ISR”) drones, intelligence, surveillance, target acquisition, and reconnaissance (“ISTAR”) drones, etc.), or any other suitable communication subsystems (e.g., a passive vision based approach). Instead of transmitting RF as a form of communication, each AV may have camera sensors on them that may be configured to visually observe the movements of the other AVs. The AVs may include a pre-programmed “language” (e.g., through use of at least partially common OCS protocol look-up tables 19dt stored locally on the AVs and any suitable OCS protocol application 19a that may be run on each AV (e.g., to provide any suitable OCSM system(s) on board each AV)). If an AV in a swarm of AVs wants to communicate with one or some or each of the other AVs in the swarm, it may be configured to “shake” or move in a unique way (e.g., as may be defined by any suitable optical configuration(s) 19oc of the OCS protocol) as a way to transmit an associated message to the other AV(s). This shaking may be visually observed by the other AV(s) and it/they may be configured to execute future maneuvers based on the received passive, visual communication (e.g., by identifying a particular message 19om of a particular OCS protocol entry 19p that may also include an optical detection 19od detected by the other AV(s) when sensing the execution of the optical reconfiguration by the transmitting AV).

It may be desirable for AVs (e.g., drones) in a swarm to communicate without being detected. For example, certain RF transmission may enable detection, so this new concept has been developed where AVs may include any suitable optical camera system and can see what other AVs are doing. If one AV sees something of interest, that AV may be configured to reconfigure itself in some way (e.g., move, fly, jiggle, shake, adjust lighting and/or shape and/or temperature of any suitable component(s), and/or the like in any suitable way) that can be optically sensed and decoded (e.g., through line of sight), as visual cues, by one or more other AVs in the swarm.

An unmanned or autonomous AV may be an airplane, a helicopter, or a multirotor drone. Alternatively, it may correspond to a terrain vehicle, an aquatic vehicle, a hover vehicle, an autonomous vehicle, or any other machine that can be programmed to move within an environment.

Visual communication (“VIZCOM”) may be a passive visual communications system that can allow for two or more AVs (e.g., two or more AVs in a swarm (e.g., as shown in FIG. 1C)) to interact without detection or exploitation. In some embodiments, the system may be based on the use of one or more OCS components (e.g., tubes (e.g., carbon fiber tubes) or rods or the like (e.g., four rod OCS components 16c-1, 16c-2, 16c-3, and 16c-4)) that may be coupled in any suitable way to at least one of the AVs for enabling it to communicate with at least one target (e.g., at least one other AV in a swarm or a control station or the like). For example, one, some, or each OCS component may be coupled to an actuator on the AV (e.g., output component 16oc-1 for controlling OCS component 16c-1, output component 16oc-2 for controlling OCS component 16c-2, etc.) that may be operative to move one, some, or each of the OCS components between two or more states (e.g., by lowering, elevating, rotating, spinning, extending, contracting, crossing, or otherwise moving one OCS component or moving two OCS components with respect to each other), where the state(s) may depend on a communication or language protocol or language that may be shared with (e.g., known by) the communicating AV and a target entity. One, some, or each OCS component may be lightweight and/or may be color coded or include one or more brightness or color variable light sources to provide additional variable characteristics or syntax to the communication. In some embodiments, one or more OCS components may be otherwise functional components of the communication subsystem (e.g., one or more legs 11g of housing 11 (e.g., as may be used for providing feet 11f for enabling proper take-off and landing of an AV) may also be configured (e.g., between take-off and landing) as an OCS component that may lower, elevate, rotate, spin, extend, contract, cross, and/or otherwise move, adjust its color and/or shape and/or temperature and/or the like when being used as an OCS component for optical communication). One or more sensors may be made available on the target entity (e.g., cameras, LIDAR, motion sensors, infrared sensors, ultrasonic sensors, thermal cameras, gesture detectors, dual-technology motion detectors, motion capture sensing technologies, image cameras, video cameras, light sensors, and/or the like) that may detect and process such OCS component reconfiguration or movement on the communicating AV (e.g., detect and process rod changing states) and any suitable software, firmware, hardware, and/or the like may be utilized to process these detected changing component states in order to interpret the communication (e.g., through use of a communication or language protocol or language that may be shared with (e.g., known by) the communicating AV and a target entity (e.g., as may be stored in a memory of or accessible to that target (e.g., that may also be independently accessible by the source AV)) in order to configure the target device to react accordingly (e.g., understand and respond to the communication).

In some embodiments, as shown in FIG. 1B, four OCS components (e.g., four rod OCS components 16c-1, 16c-2, 16c-3, and 16c-4) may be coupled to an AV and each may be positioned in a first component state (e.g., each component may be coupled at a first end to a feature (e.g., actuator) of the AV and may extend out horizontally (e.g., in an AV reference frame)). As shown in FIG. 1C, one or more of the OCS components may be repositioned from that first component state to a second component state, such as a state where two of the four OCS components may remain in the horizontal position of the first component state with a first component (e.g., component 16c-3) presenting a first color or presentation (e.g., red (e.g., characteristic changing portion 16ct-3 of OCS component 16c-3 changing from white to red or some other color change or some other characteristic change (e.g., shape, temperature, etc.)) and with a second component (e.g., component 16c-4) presenting a second color or presentation (e.g., green (e.g., characteristic changing portion 16ct-4 of OCS component 16c-4 changing from white to green or some other color change or some other characteristic change (e.g., shape, temperature, etc.))), and where the other two of the four components (e.g., component 16c-1 and component 16c-2) may now be positioned (e.g., by movement of the actuator(s)) in a vertical position with one of those components (e.g., component 16c-2) presenting a third color or presentation (e.g., blue (e.g., characteristic changing portion 16ct-2 of OCS component 16c-2 changing from white to blue or some other color change or some other characteristic change (e.g., shape, temperature, etc.))) and with another one of those components (e.g., component 16c-1 presenting a fourth color or presentation (e.g., white or yellow or the like). Such changes (e.g., using adjustable color lights or heat-adjusting component features or expandable component features or the like or any suitable patterns of such adjustments over time) between the first and second component states (e.g., no lights on vs. two lights flickering on and off in a particular pattern over a duration of time, one red light vs. three green lights, no Av movement about a Z-axis vs. rotation of the AV about the Z-axis, smooth movement of the AV along a travel path vs. quickly moving up and down along an axis or shaking in a specific manner or traveling along a uniquely shaped path detectable by a predefined optical detection of the OCS protocol, etc.) may be detected by one or more of the other AVs in a swarm and/or by any other suitable target and such detection may be utilized by that target along with any previously determined language definitions to determine any suitable statement that may have been previously associated with that detected component state change (e.g., “the communicating AV has detected a particular target” or “the communicating AV is running out of power and will be returning to base”, and/or any other suitable optical message). For example, any suitable movement of a communication subsystem in space may be associated with a particular optical message, such as a long jiggle (e.g., for 5 seconds) may be associated with a first optical message, a medium jiggle (e.g., for 3 seconds) may be associated with a second optical message, and a short jiggle (e.g., for 1 second) may be associated with a third optical message, while a repeated figure-8 shaped travel path (e.g., 3 full FIG. 8 path travels within a particular amount of time (e.g., 10 seconds) may be a fourth optical message, and/or the like.

In some embodiments, a first communication subsystem (e.g., a receiving communication subsystem (e.g., a target entity)) may be configured to have any suitable sensor (e.g., optical sensor) trained on a second communication subsystem (e.g., a transmitting communication subsystem (e.g., a communicating entity)) in order for the first communication subsystem to attempt to maintain a continuous line of sight so that it may be continuously attempting to detect relevant signal(s) 105 on a channel 103 with the second communication subsystem no matter where the second communication subsystem travels relative to the first communication subsystem. In some embodiments, the first communication subsystem may store information indicative of the planned travel path of the second communication subsystem and any particular deviation from that travel path as detectable by the first communication subsystem may be identified using the OSC protocol as a particular optical message. In some embodiments, a second communication subsystem may have a designated space that within which it ought to be when it attempts to transmit signal(s) 105, such that the first communication subsystem may remain trained on that designated space rather than continuously attempting to maintain a channel 103 with the second communication subsystem no matter where the second communication subsystem may travel relative to the first communication subsystem.

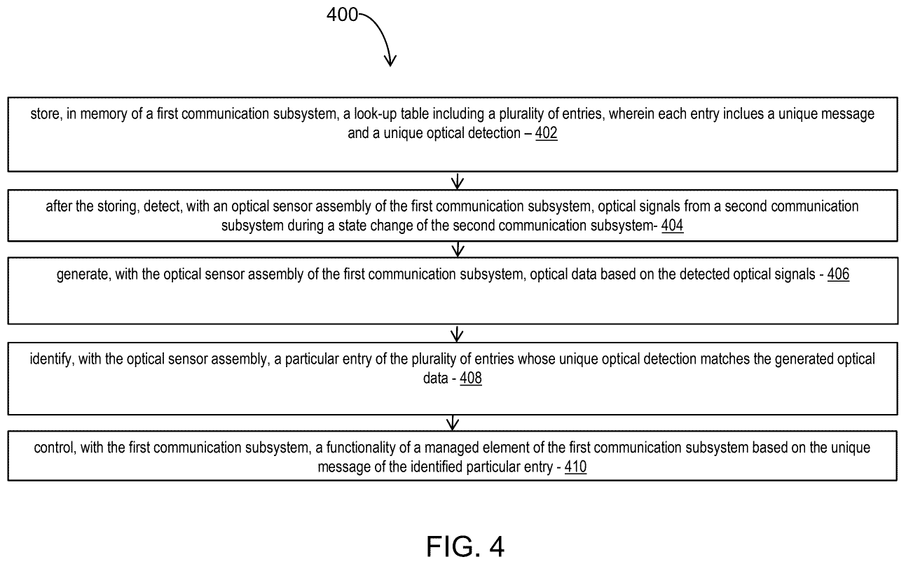

FIG. 4 is a flowchart of an illustrative process 400 for receiving at a first communication subsystem a message from a second communication subsystem. At operation 402, process 400 may include storing, in memory of the first communication subsystem, a look-up table comprising a plurality of entries, wherein each entry includes a unique message and a unique optical detection. At operation 404, process 400 may include, after the storing, detecting, with an optical sensor assembly of the first communication subsystem, optical signals from the second communication subsystem during a state change of the second communication subsystem. At operation 406, process 400 may include generating, with the optical sensor assembly of the first communication subsystem, optical data based on the detected optical signals. At operation 408, process 400 may include identifying, with the optical sensor assembly, a particular entry of the plurality of entries whose unique optical detection matches the generated optical data. At operation 410, process 400 may include controlling, with the first communication subsystem, a functionality of a managed element of the first communication subsystem based on the unique message of the identified particular entry.

The operations shown in process 400 of FIG. 4 are only illustrative and that existing operations may be modified or omitted, additional operations may be added, and the order of certain operations may be altered.

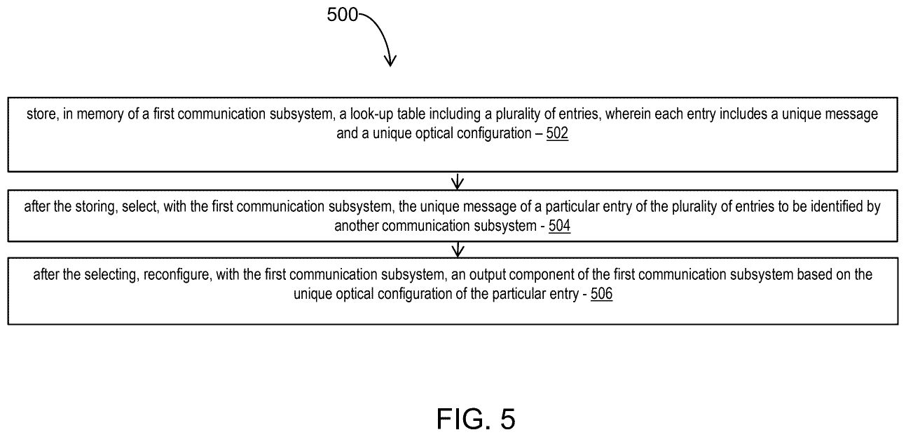

FIG. 5 is a flowchart of an illustrative process 500 for communicating a message from a first communication subsystem. At operation 502, process 500 may include storing, in memory of the first communication subsystem, a look-up table including a plurality of entries, wherein each entry includes a unique message and a unique optical configuration. At operation 504, process 500 may include, after the storing, selecting, with the first communication subsystem, the unique message of a particular entry of the plurality of entries to be identified by another communication subsystem. At operation 506, process 500 may include, after the selecting, reconfiguring, with the first communication subsystem, an output component of the first communication subsystem based on the unique optical configuration of the particular entry.

The operations shown in process 500 of FIG. 5 are only illustrative and that existing operations may be modified or omitted, additional operations may be added, and the order of certain operations may be altered.

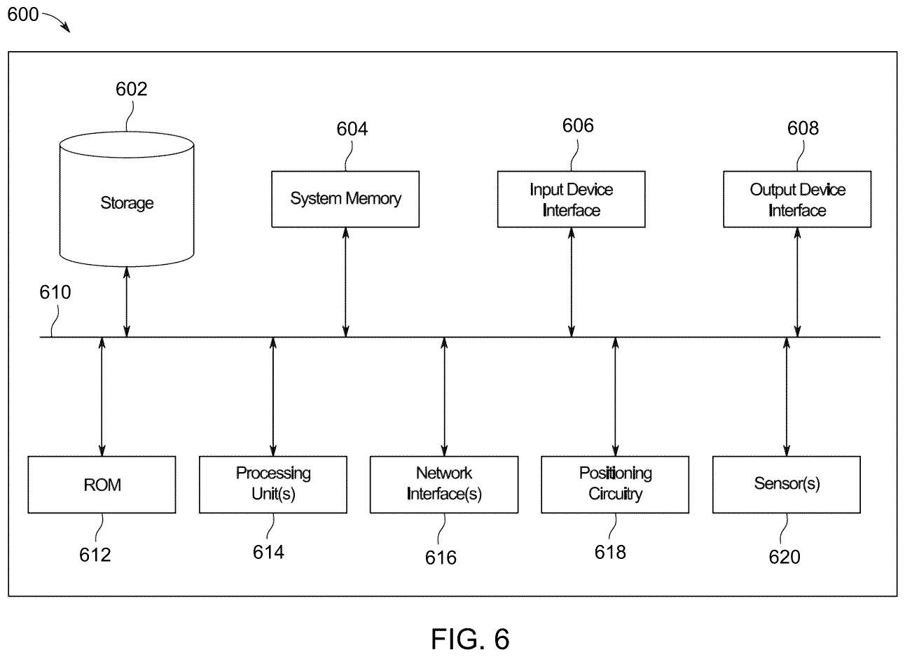

FIG. 6 illustrates an electronic system 600 with which one or more implementations of the subject technology may be implemented. Electronic system 600 can be, and/or can be a part of, any of subsystems 100-106 for generating the features and processes described herein. Electronic system 600 may include various types of computer-readable media and interfaces for various other types of computer-readable media. Electronic system 600 may include a permanent storage device 602, a system memory 604 (and/or buffer), an input device interface 606, an output device interface 608, a bus 610, a ROM 612, one or more processing unit(s) 614, one or more network interface(s) 616, positioning circuitry 618, sensor(s) 620, and/or subsets and variations thereof.

Bus 610 may collectively represent all system, peripheral, and chipset buses that may communicatively couple or connect the numerous internal devices of electronic system 600. In one or more implementations, bus 610 may communicatively couple one or more processing unit(s) 614 with ROM 612, system memory 604, and permanent storage device 602. From these various memory units, one or more processing unit(s) 614 may retrieve instructions to execute and data to process in order to execute the processes of the subject disclosure. One or more processing unit(s) 614 can be a single processor or a multi-core processor in different implementations.

ROM 612 may store static data and instructions that may be needed by one or more processing unit(s) 614 and other modules of electronic system 600. Permanent storage device 602, on the other hand, may be a read-and-write memory device. Permanent storage device 602 may be a non-volatile memory unit that stores instructions and data even when electronic system 600 is off. In one or more implementations, a mass-storage device (e.g., a magnetic or optical disk and its corresponding disk drive) may be used as permanent storage device 602.

In one or more implementations, a removable storage device (e.g., a floppy disk, flash drive, and its corresponding disk drive) may be used as permanent storage device 602. Like permanent storage device 602, system memory 604 may be a read-and-write memory device. However, unlike permanent storage device 602, system memory 604 may be a volatile read-and-write memory, such as random access memory. System memory 604 may store any of the instructions and data that one or more processing unit(s) 614 may need at runtime. In one or more implementations, the processes of the subject disclosure may be stored in system memory 604, permanent storage device 602, and/or ROM 612. From these various memory units, one or more processing unit(s) 614 may retrieve instructions to execute and data to process in order to execute the processes of one or more implementations.

Bus 610 may also couple to input and output device interfaces 606 and 608. Input device interface 606 may enable a user to communicate information and select commands to electronic system 600. Input devices that may be used with input device interface 606 may include, for example, alphanumeric keyboards and pointing devices (also called “cursor control devices”). Output device interface 608 may enable, for example, the display of images generated by electronic system 600. Output devices that may be used with output device interface 608 may include, for example, printers and display devices, such as a liquid crystal display (“LCD”), a light emitting diode (“LED”) display, an organic light emitting diode (“OLED”) display, a flexible display, a flat panel display, a solid state display, a projector, or any other device for outputting information.

One or more implementations may include devices that function as both input and output devices, such as a touchscreen. In these implementations, feedback provided to a user can be any form of sensory feedback, such as visual feedback, auditory feedback, or tactile feedback; and input from a user can be received in any form, including acoustic, speech, or tactile input.

Bus 610 may also couple to positioning circuitry 618 and sensor(s) 620. Positioning circuitry 618 may be used in determining device location based on positioning technology. For example, positioning circuitry 618 may provide for one or more of GNSS positioning, wireless access point positioning, cellular phone signal positioning, Bluetooth signal positioning, image recognition positioning, an INS (e.g., via motion sensors such as an accelerometer and/or gyroscope), and/or localization system(s).

In one or more implementations, sensor(s) 620 may be utilized to detect movement, travel, and/or orientation of electronic system 600. For example, the sensor(s) may include an accelerometer, a rate gyroscope, and/or other motion-based sensor(s). Alternatively or in addition, sensor(s) 620 may include one or more audio sensors(s) and/or image-based sensor(s) for determining device position. In another example, sensor(s) 620 may include a barometer, which may be utilized to detect atmospheric pressure (e.g., corresponding to device altitude). In another example, sensor(s) 620 may include image sensor(s).

Finally, as shown in FIG. 6, bus 610 may also couple electronic system 600 to one or more networks and/or to one or more network nodes through one or more network interface(s) 616. In this manner, electronic system 600 can be a part of a network of computers (e.g., a local area network (“LAN”), a wide area network (“WAN”)), or an Intranet, or a network of networks, such as the Internet. Any or all components of electronic system 600 can be used in conjunction with the subject disclosure.

One, some, or all of the processes described with respect to FIGS. 1-6 and otherwise may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1A). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure (e.g., any or each module of system 1) may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure (e.g., system 1) may be stored in or otherwise accessible to a subsystem in any suitable manner (e.g., in memory 13 (e.g., as at least a portion of application 19a and/or model 19m)). Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip). At least a portion of one or more of the modules of any suitable system of the disclosure (e.g., system 1) may be stored in or otherwise accessible to any suitable components in any suitable manner. Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip).

Any or each module of any suitable system of the disclosure (e.g., system 1) may be a dedicated system implemented using one or more expansion cards adapted for various bus standards. For example, all of the modules may be mounted on different interconnected expansion cards or all of the modules may be mounted on one expansion card. With respect to system 1, by way of example only, modules of system 1 may interface with a motherboard or processor assembly 12 (e.g., of subsystem 101) through an expansion slot (e.g., a peripheral component interconnect (“PCI”) slot or a PCI express slot). Alternatively, modules of system 1 need not be removable but may include one or more dedicated modules that may include memory (e.g., RAM) dedicated to the utilization of the module. In other embodiments, modules of system 1 may be at least partially integrated into a subsystem (e.g., subsystem 101 (e.g., a server)). For example, a module of system 1 may utilize a portion of memory 13 of a subsystem. Any or each module of system 1 may include its own processing circuitry and/or memory. Alternatively, any or each module of system 1 may share processing circuitry and/or memory with any other module of system 1 and/or processor assembly 12 and/or memory assembly 13 of a subsystem (e.g., subsystem 101).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Any suitable system model (e.g., one or more models 19m) may be developed and/or generated for use in evaluating and/or predicting output states. For example, a model may be a learning engine for an experiencing entity, where the learning engine may be operative to use any suitable machine learning (“ML”) (e.g., the system's ability to learn automatically from past events to affect future behavior) to use certain monitored system data for a particular environment (e.g., at a particular time and/or with respect to one or more planned activities) in order to predict, estimate, and/or otherwise generate an output state. For example, the learning engine may include any suitable neural network (e.g., an artificial neural network) that may be initially configured, trained on one or more sets of monitored system data that is associated with known or otherwise determined or confirmed states or data from any suitable sources, and then used to predict further states based on another set of monitored system data.

A neural network or neuronal network or artificial neural network may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

Different input neurons of the neural network may be associated with respective different types of monitored system data categories and may be activated by monitored system data of the respective monitored system data categories (e.g., each possible category of monitored system data variable information may be associated with one or more particular respective input neurons of the neural network and monitored system data for the particular monitored system data category may be operative to activate the associated input neuron(s)). The weight assigned to the output of each neuron may be initially configured using any suitable determinations that may be made by a custodian or processor of the model based on the data available to that custodian.

The initial configuring of the learning engine or management model for a particular system (e.g., the initial weighting and arranging of neurons of a neural network of the learning engine) may be done using any suitable data accessible to a custodian of the management model, such as data associated with the configuration of other learning engines of the system (e.g., learning engines or management models for other systems), data associated with the particular system (e.g., initial background data accessible by the model custodian about the particular system composition, location, past uses, and/or the like), data assumed or inferred by the model custodian using any suitable guidance, and/or the like. For example, a model custodian may be operative to capture any suitable initial background data about a particular system in any suitable manner, which may be enabled by any suitable user interface provided to an appropriate subsystem or device accessible to one, some, or each operator or entity with knowledge of the particular system (e.g., a model app or website). The model custodian may provide a data collection portal for enabling any suitable entity to provide initial background data for the particular system. The data may be uploaded in bulk or manually entered in any suitable manner.

A management model custodian may receive not only monitored system data for at least one monitored system data category for a particular system experience but also a system output product state for that system experience. This may be enabled by monitoring any suitable system data for a system. The management model custodian may provide a data collection portal for enabling any suitable entity(ies) to provide such data. The system output state may be received and may be derived from the system in any suitable manner.

A learning engine or model (e.g., a service system management model) for a system may be using the received monitored system data for the system experience (e.g., as inputs of a neural network of the learning engine) and using the received system output product state for the system experience (e.g., as an output of the neural network of the learning engine). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving monitored system data and a system output product state for a system experience (e.g., a particular system in a particular environment at a particular moment) and then training the system model using the received monitored system data and system output product state may be repeated any suitable number of times for the same system(s) in different system experiences (e.g., in same or different environments at different moments) and the same learning engine for more effectively training the learning engine for the system, where the received monitored system data and the received system output product state of different receipt and train loops may be for different environments or for the same environment (e.g., at different times and/or with respect to different planned activities) and/or may be received from the same source or from different sources of the system, while the training of different receipt and train loops may be done for the same learning engine using whatever monitored system data and system output product state was received for the particular receipt and train loop. The number and/or type(s) of the one or more monitored system data categories for which monitored system data may be received for one receipt and train loop may be the same or different in any way(s) than the number and/or type(s) of the one or more monitored system data categories for which monitored system data may be received for a second receipt and train loop.

A trained model may then receive input data from any suitable source using any suitable methods for use by the model. The trained model may then use this new input data to generate output data using the learning engine or model. For example, the new input data may be utilized as input(s) to the neural network of the learning engine similarly to how other input data accessed for a receipt and train loop may be utilized as input(s) to the neural network of the learning engine at a training portion of the receipt and train loop, and such utilization of the learning engine with respect to the new input data may result in the neural network providing an output indicative of data that may represent the learning engine's predicted or estimated result.

The processing power and speed of any suitable optical communication system and its various models may be configured to determine continuously an updated system output product state of a system and present associated information or otherwise adjust a managed element based on the determined system output product state automatically and instantaneously or substantially instantaneously based on any new received monitored system data that may be generated by the system, such that management of the system may run quickly and smoothly. This may enable the system to operate as effectively and as efficiently as possible.

The use of one or more suitable models or engines or neural networks or the like may enable prediction or any suitable determination of an output product state of a system in a system experience. Such models (e.g., neural networks) running on any suitable processing units (e.g., graphical processing units (“GPUs”) that may be available to the system) provide significant speed improvements in efficiency and accuracy with respect to prediction over other types of algorithms and human-conducted analysis of data, as such models can provide estimates in a few milliseconds or less, thereby improving the functionality of any computing device on which they may be run. Due to such efficiency and accuracy, such models enable a technical solution for enabling the generation of any suitable control data (e.g., for controlling any suitable functionality of any suitable managed element) using any suitable real-time data (e.g., data made available to the models) that may not be possible without the use of such models, as such models may increase performance of their computing device(s) by requiring less memory, providing faster response times, and/or increased accuracy and/or reliability. Due to the condensed time frame and/or the time within which a decision with respect to system data ought to be made to provide a desirable use experience, such models offer the unique ability to provide accurate determinations with the speed necessary to enable effective and efficient use management.

As may be used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

One aspect of the present technology may be the gathering and use of data available from various sources to improve the detection of a user. The present disclosure contemplates that in some instances, this gathered data may include personal information data that uniquely identifies or can be used to contact or locate a specific person. Such personal information data can include demographic data, location-based data, telephone numbers, email addresses, social network identifiers, home addresses, office addresses, data or records relating to a user's health or level of fitness (e.g., vital signs measurements, facial expression measurements, medication information, exercise information, etc.) and/or mindfulness, date of birth, or any other identifying or personal information.

While there have been described systems, methods, and computer-readable media for optically communicating between vehicles, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

What is claimed is:

1. A method of receiving at a first communication subsystem a message from a second communication subsystem, the method comprising:
storing, in memory of the first communication subsystem, a look-up table comprising a plurality of entries, wherein each entry comprises a unique message and a unique optical detection;
after the storing, detecting, with an optical sensor assembly of the first communication subsystem, optical signals from the second communication subsystem during a state change of the second communication subsystem;
generating, with the optical sensor assembly of the first communication subsystem, optical data based on the detected optical signals;
identifying, with the optical sensor assembly, a particular entry of the plurality of entries whose unique optical detection matches the generated optical data; and
controlling, with the first communication subsystem, a functionality of a managed element of the first communication subsystem based on the unique message of the identified particular entry.

2. The method of claim 1, further comprising, during the detecting, obtaining, with an inertial sensor assembly of the first communication subsystem, inertial data of the optical sensor assembly, wherein the identifying is based on the obtained inertial data.

3. A method of communicating a message from a first communication subsystem, the method comprising:
storing, in memory of the first communication subsystem, a look-up table comprising a plurality of entries, wherein each entry comprises a unique message and a unique optical configuration;
after the storing, selecting, with the first communication subsystem, the unique message of a particular entry of the plurality of entries to be identified by another communication subsystem; and
after the selecting, reconfiguring, with the first communication subsystem, an output component of the first communication subsystem based on the unique optical configuration of the particular entry.

4. The method of claim 3, further comprising, during the selecting, obtaining, with an inertial sensor assembly of the first communication subsystem, inertial data of the output component, wherein the reconfiguring is based on the obtained inertial data.

5. The method of claim 3, wherein the reconfiguring comprises moving the first communication subsystem in space based on the unique optical configuration of the particular entry.

6. The method of claim 3, wherein the reconfiguring comprises moving the output component relative to another component of the first communication subsystem based on the unique optical configuration of the particular entry.

7. The method of claim 6, wherein:
the first communication subsystem is a drone; and
the output component comprises a leg of the drone.

8. The method of claim 3, wherein the reconfiguring comprises changing a color of the output component based on the unique optical configuration of the particular entry.

9. The method of claim 3, wherein the reconfiguring comprises changing a temperature of the output component based on the unique optical configuration of the particular entry.

10. The method of claim 3, wherein the reconfiguring comprises changing a shape of the output component based on the unique optical configuration of the particular entry.
